(19) United States
(12) Patent Application Publication
(10) Pub. No.: US 2025/0059030 A1
(43) Pub. Date: Feb. 20, 2025

(54) MEMBRANE REACTOR SYSTEM FOR FUEL REFORMING AND HYDROGEN PRODUCTION

(71) Applicant: KING FAHD UNIVERSITY OF PETROLEUM AND MINERALS, Dhahran (SA)

(72) Inventor: Medhat Ahmed Abdallah NEMITALLAH, Dhahran (SA)

(73) Assignee: KING FAHD UNIVERSITY OF PETROLEUM AND MINERALS, Dhahran (SA)

(21) Appl. No.: 18/451,528

(22) Filed: Aug. 17, 2023

(51) Int. Cl. C01B 3/26

(52) U.S. Cl. CPC C01B 3/26; C01B 2203/0233; C01B 2203/1058; C01B 2203/1241; C01B 2203/1623

(57) ABSTRACT

A membrane reactor (MR) system includes an enclosure. The enclosure includes a shell, a front cap and a back cap. The shell is porous and includes a steam-methane reforming (SMR) catalyst. The MR system includes a feed inlet fluidly connected to the enclosure and configured to receive a feed gas comprising CH₄ and H₂O. At least one tube is disposed inside the enclosure and having a sidewall defining a feed side and a sweep side. The feed side is connected to the feed inlet to receive the feed gas that is configured to produce H2 catalyzed by the SMR catalyst of the shell. The sidewall includes a palladium silver (Pd—Ag) membrane configured to selectively permeate the H₂ from the feed side to the sweep side. A sweep inlet is connected to the sweep side and configured to receive a sweep gas to carry and transport the H₂.

### STATEMENT OF PRIOR DISCLOSURE BY AN INVENTOR

Aspects of the present disclosure are related to “Characteristics of Hydrogen Separation and Methane Steam Reforming in a Pd-Based Membrane Reactor of Shell and Tube Design”, Case Studies in Thermal Engineering Volume 45, 102939, 2023.

### STATEMENT OF ACKNOWLEDGEMENT

The support received from King Fahd University of Petroleum & Minerals through the interdisciplinary research center on hydrogen and energy storage (IRC-HES) on project number, INHE2102 and the support provided by King Abdullah City for Atomic and Renewable Energy (K.A. CARE) is gratefully acknowledged.

### BACKGROUND

### Technical Field

The present disclosure is directed to a membrane reactor (MR) system for fuel reforming and hydrogen production.

### Description Of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Fossil fuel is expected to meet the basic energy demand for the coming decades, leading to excessive increase in greenhouse gas emissions that directly contribute to global warming. This situation can improve if more stringent legislation is applied in parallel with the implementation of innovative technologies for clean energy production. Hydrogen fuel, derived from either fossil or renewable sources, presents itself as an alternative route to clean energy production. Hydrogen, as the simplest chemical molecule, burns cleanly and efficiently when used directly in conventional combustion systems. Additionally, it can be effectively utilized for electric power generation in fuel cells. Hydrogen finds diverse applications, including desulfurization, the production of chemicals (e.g. methanol, ethanol, etc.), petroleum refining, and hydro-treating.

The main feedstocks for various hydrogen production processes are gaseous hydrocarbon fuels such as methane, methanol, ethanol, kerosene, ketones, dimethyl ether, and the like. These processes involve partial oxidation reactions of hydrocarbon fuels (mainly natural gas), steam/dry/autothermal reforming reactions, decomposition reactions, and coal gasification. Additionally, hydrogen can be produced, though at higher cost, through water electrolysis. Among these processes, the steam methane reforming (SMR) pathway presents the most economic approach for commercial hydrogen production. The produced gas (H₂+CO₂+CO) of SMR is highly H₂-concentrated, which facilitates its separation process. However, the overall SMR process reactions are reversible and highly endothermic, thus requiring a huge heat input. In most commercial installations for hydrogen production using SMR, a significant portion of methane (about 30%) is burned to heat up the reformer tubes. To save such a significant portion of the feedstock fuel, concentrated solar energy can be used as the source of heat for the SMR process. However, the required high temperature for SMR (800-950° C.) limits the design of the solar system to solar dishes and central receivers, which can be expensive. Instead, molten salt can be used to transfer solar energy to the reformer indirectly through the implementation of parabolic trough technology at temperatures ranging from 400 to 600° C. However, this temperature range is much below the required range for SMR, making this process thermodynamically limited. This limitation can be overcome by shifting the equilibrium of reactions towards the formation of H₂ through the continuous removal of H₂ from the reaction zone using H₂-selective separation membranes inside what is called a membrane reactor (MR). The reactor combines the processes of chemical reaction and gas separation in one stage and includes a reaction chamber for SMR, in addition to the membrane to remove the produced H₂. This process can achieve full conversion of methane at temperatures below 600° C.

Inorganic Palladium (Pd) membranes have demonstrated a great potential to produce ultrapure hydrogen due to their stability and high selectivity for hydrogen. The separation process requires a significant pressure difference across the membranes to separate H₂ (about 10 bars). However, that is not a big challenge as natural gas is already pressurized far above this requirement. All processes for hydrogen production result in hydrogen-rich gas mixtures (with impurities like CO, CO₂, H₂O, etc.) that require post-processing purification processes to obtain pure hydrogen for industrial applications or energy production. The most common purification processes for pure hydrogen production are cryogenic distillation, pressure swing adsorption, and solvent adsorption. Membrane reactors are considered as an efficient technique to replace conventional technologies for processing, separation, and conversion. Considering the current advances in membrane materials for gas separation, membrane reactors can offer better performance and high adaptability at reasonable cost.

Palladium-based membrane reactors are commonly used when hydrogen is the gas to be separated. Palladium-based membranes are characterized by a great potential for producing ultrapure hydrogen due to their high stability without fatigue, low energy requirements, and high selectivity for hydrogen. Moreover, the mechanical and thermal stability of Pd-membranes can be further enhanced, along with improvements in the tolerance for membrane poisoning, by combining Pd with another element to create a Pd-alloy. Adding Ag to Pd to form a Pd—Ag alloy membrane results in higher hydrogen permeability, about 1.17 times compared to the pure Pd membrane. The composition of a particular Pd-alloy significantly influences the activation energy required to pass H₂ molecules across a Pd membrane.

The variations of activation energy for H₂ diffusion in Pd—Ag membranes has been described (See: G. L. Holleck, “Diffusion and solubility of hydrogen in palladium and palladium-silver alloys”, J. Phys. Chem. 74 (3) (1970), 503-511, incorporated herein by reference in its entirety) including activation energies of 11 and 6 KJ/mol for pure Pd and Pd—Ag (70-330% by weight) membranes, respectively (See: H. Amandusson et. al, “Hydrogen permeation through surface modified Pd and PdAg membranes”, J. Membr. Sci. 193 (1) (2001), 35-47, incorporated herein by reference in its entirety). JP2008044812A describes a method of manufacturing hydrogen using a perm-selective membrane type reactor. U.S. Pat. No. 6,348,278B1 describes a method and a system for producing hydrogen in a reforming reactor that can be supplied to a fuel cell. Each of the aforementioned references suffers from one or more drawbacks hindering their adoption.

Accordingly, there is a need for systems and methods for fuel reforming and hydrogen production.

### SUMMARY

In an exemplary embodiment, a membrane reactor (MR) system is disclosed. The MR system includes an enclosure. The enclosure includes a shell, a front cap and a back cap. The shell is porous and includes a steam-methane reforming (SMR) catalyst. The MR system includes a feed inlet connected to the enclosure and configured to receive a feed gas comprising CH₄ and H₂O. The MR system includes at least one tube disposed inside the enclosure and having a sidewall defining a feed side and a sweep side. The feed side is fluidly connected to the feed inlet to receive the feed gas that is configured to produce H₂ catalyzed by the SMR catalyst of the shell. The sidewall includes a palladium silver (Pd—Ag) membrane configured to selectively permeate the H₂ from the feed side to the sweep side. The MR system includes a sweep inlet connected to the sweep side and configured to receive a sweep gas to carry and transport the H₂. The MR system includes a production outlet connected to the tube and configured to discharge the sweep gas and the H₂. The MR system includes a retentate outlet connected to the enclosure and configured to discharge the feed gas.

In some embodiments, the enclosure includes a casing surrounding the shell.

In some embodiments, the SMR catalyst includes a nickel aluminum oxide alloy including 20-40 wt. % of nickel based on a total weight of the nickel aluminum oxide alloy.

In some embodiments, the nickel aluminum oxide alloy has a bed porosity of 0.3-0.5.

In some embodiments, the nickel aluminum oxide alloy has an average particle diameter of 2.5-4.5 mm and a catalyst density of 2000-2700 kg/m³.

In some embodiments, the shell is longer than the Pd—Ag membrane along a longitudinal direction of the shell, and the feed inlet is offset from the Pd—Ag membrane along the longitudinal direction of the shell so that the feed gas is configured to produce the H₂ before contacting the Pd—Ag membrane.

In some embodiments, the MR system includes a plurality of shells each being porous and comprising the SMR catalyst and a plurality of tubes each comprising the Pd—Ag membrane, and the plurality of shells and the plurality of tubes are arranged concentrically and alternately.

In some embodiments, the plurality of shells includes an outmost shell and an innermost shell, between which each tube is positioned between two neighboring shells and has a respective sweep side and two respective feed sides.

In some embodiments, the shell is spaced apart from the tube with no SMR catalyst in between.

In some embodiments, the sidewall of the tube includes Inconel to support the Pd—Ag membrane.

In some embodiments, the sweep gas includes water steam.

In some embodiments, the water steam is pre-heated to 600-900 K before received by the sweep inlet.

In some embodiments, the feed gas further includes carbon oxide and hydrogen.

In some embodiments, the MR system includes the feed inlet and the sweep inlet are respectively connected to the front cap so that the feed gas and the sweep gas are configured to flow in a same direction in the shell.

In some embodiments, the feed inlet and the sweep inlet are respectively connected to the front cap and the back cap so that the feed gas and the sweep gas are configured to flow in opposite directions in the shell.

In some embodiments, the tube and the shell are arranged concentrically.

In some embodiments, the MR system includes a plurality of tubes arranged in a square pattern.

In some embodiments, the enclosure is cylindrical.

In some embodiments, each tube has a diameter of 10-20 millimeters, a thickness of 5-20 micrometers, and a length of 0.25-1.0 meters.

In some embodiments, the MR system includes a plurality of tubes arranged in a square pattern. Neighboring tubes have a spacing of less than 22 mm. An empty volume of an enclosed space defined by the casing represents space not occupied by any of the plurality of tubes in the enclosed space is less than 10 vol % of a total volume of the enclosed space.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A shows a block diagram of a membrane reactor (MR) system, according to certain embodiments;

FIG. 1B shows a cross-sectional view of the MR system, according to certain embodiments;

FIG. 1C shows another view of the MR system, according to certain embodiments;

FIG. 2 shows a schematic representation of an integration domain for numerical calculations in X-Y plane, extended in the Z-direction for the entire length of the MR system, according to certain embodiments;

FIG. 3A shows a plot illustrating comparison of counter-current flow configuration and co-current flow configuration in terms of axial distributions of hydrogen permeation flux, according to certain embodiments;

FIG. 3B shows a plot illustrating comparison of counter-current flow configuration and co-current flow configuration in terms of axial distributions of hydrogen partial pressure on both sides of the membrane, according to certain embodiments;

FIG. 3C shows a plot illustrating comparison of counter-current flow configuration and co-current flow configuration in terms of axial distributions of averaged mole fraction of hydrogen in the shell side, according to certain embodiments.

FIG. 4A shows a plot illustrating the co-current flow configuration in terms of radial distributions of hydrogen mole fraction at different axial locations on an axial plane inclined by 45° (X-Y), according to certain embodiments;

FIG. 4B shows a plot illustrating the counter-current flow configuration in terms of radial distributions of hydrogen mole fraction at different axial locations on an axial plane inclined by 45° (X-Y), according to certain embodiments;

FIG. 5A shows a two-dimensional (2D) contour plot of hydrogen mole fraction on X-Y planes at axial location of Z=0.1 m for a base case (case 2) of co-current flow configuration, according to certain embodiments;

FIG. 5B shows a 2D contour plot of hydrogen mole fraction on X-Y planes at axial location of Z=0.2 m for the base case (case 2) of co-current flow configuration, according to certain embodiments;

FIG. 5C shows a 2D contour plot of hydrogen mole fraction on X-Y planes at axial location of Z=0.3 m for the base case (case 2) of co-current flow configuration, according to certain embodiments;

FIG. 5D shows a 2D contour plot of hydrogen mole fraction on X-Y planes at axial location of Z=0.4 m for the base case (case 2) of co-current flow configuration, according to certain embodiments;

FIG. 6A shows a plot representing an effect of feeding pressure in the membrane feed side on the axial distributions of hydrogen permeation flux on both sides of the membrane, according to certain embodiments;

FIG. 6B shows a plot representing an effect of feeding pressure in the membrane feed side on the axial distributions of hydrogen partial pressure on both sides of the membrane, according to certain embodiments;

FIG. 7A shows a plot representing an effect of feeding pressure of 15 bars in the feed side on radial distributions of hydrogen mole fraction at different axial locations on an axial plane inclined by 45° (X-Y), according to certain embodiments;

FIG. 7B shows a plot representing an effect of feeding pressure of 30 bars in the feed side on radial distributions of hydrogen mole fraction at different axial locations on an axial plane inclined by 45° (X-Y), according to certain embodiments;

FIG. 8A shows a plot representing an effect of inlet gas temperature on the hydrogen permeation flux on both sides of the membrane, according to certain embodiments;

FIG. 8B shows a plot representing an effect of inlet gas temperature on the distributions of hydrogen partial pressure on both sides of the membrane, according to certain embodiments;

FIG. 9A shows a plot representing an effect of inlet gas temperature of 900 K (case 7) on radial distributions of hydrogen mole fraction at different axial locations on an axial plane inclined by 45° (X-Y), according to certain embodiments;

FIG. 9B shows a plot representing an effect of inlet gas temperature of 700 K (case 8) on radial distributions of hydrogen mole fraction at different axial locations on an axial plane inclined by 45° (X-Y), according to certain embodiments;

FIG. 10A shows a plot representing an effect of feed gas concentrations on the axial distributions of the hydrogen permeation flux on both sides of a membrane, according to certain embodiments;

FIG. 10B shows a plot representing an effect of feed gas concentrations on the axial distributions of the hydrogen partial pressure on both sides of the membrane, according to certain embodiments;

FIG. 11A shows a plot representing an effect of feed gas concentrations (case 5) on radial distributions of hydrogen mole fraction at different axial locations on an axial plane inclined by 45° (X-Y), according to certain embodiments;

FIG. 11B shows a plot representing an effect of feed gas concentrations (case 6) on radial distributions of hydrogen mole fraction at different axial locations on an axial plane inclined by 45° (X-Y), according to certain embodiments;

FIG. 12A shows a plot representing axial distributions of hydrogen permeation flux, according to certain embodiments;

FIG. 12B shows a plot representing hydrogen partial pressure on both sides of the membrane, according to certain embodiments;

FIG. 12C shows a plot representing temperature within the MR system under combined reforming and hydrogen separation conditions, according to certain embodiments;

FIG. 13A shows a plot representing contours of temperature (K) on X-Y planes at different axial locations within the MR system under combined reforming and hydrogen separation conditions such as Z=0.1 m, according to certain embodiments;

FIG. 13B shows a plot representing contours of temperature (K) on X-Y planes at different axial locations within the MR system under combined reforming and hydrogen separation conditions such as Z=0.2 m, according to certain embodiments;

FIG. 13C shows a plot representing contours of temperature (K) on X-Y planes at different axial locations within the MR system under combined reforming and hydrogen separation conditions such as Z=0.3 m, according to certain embodiments;

FIG. 13D shows a plot representing contours of temperature (K) on X-Y planes at different axial locations within the MR system under combined reforming and hydrogen separation conditions such as Z=0.4 m, according to certain embodiments;

FIG. 14A shows a contour plot showing the axial distributions of species mole fractions on axial plane of 45° (X-Y) crossing the center of the membrane tube under combined reforming and hydrogen separation conditions for CH₄, according to certain embodiments;

FIG. 14B shows a contour plot showing the axial distributions of species mole fractions on axial plane of 45° (X-Y) crossing the center of the membrane tube under combined reforming and hydrogen separation conditions for CO, according to certain embodiments;

FIG. 14C shows a contour plot showing the axial distributions of species mole fractions on axial plane of 45° (X-Y) crossing the center of the membrane tube under combined reforming and hydrogen separation conditions for H₂, according to certain embodiments; and

FIG. 15 shows a cross-sectional view of the MR system, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to a membrane reactor (MR) system of porous-shell and multi-tubes design, for hydrogen production at the commercial scale. The design of the MR system is optimized for the highest hydrogen permeation under non-reacting conditions (no reforming reactions).

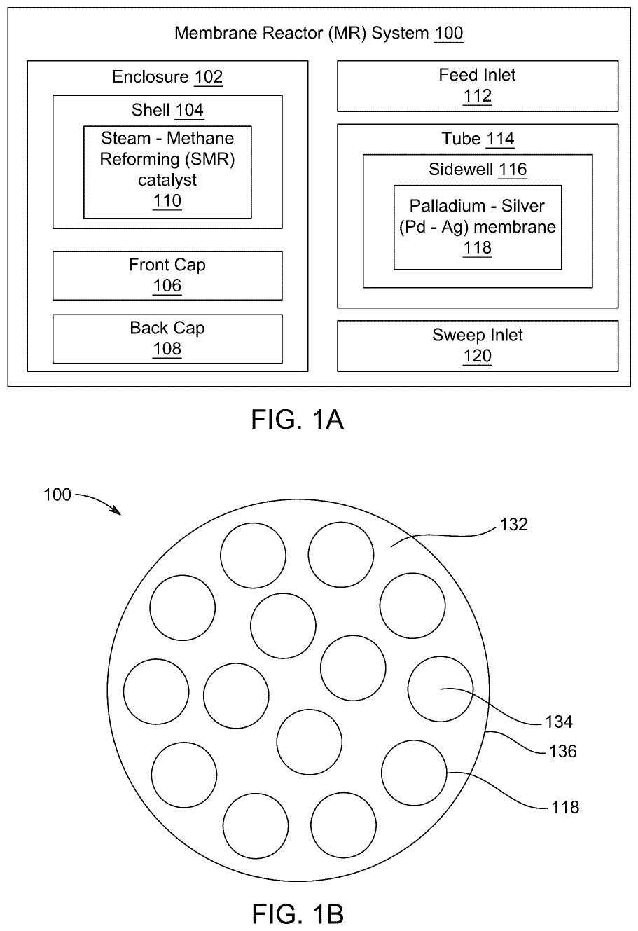

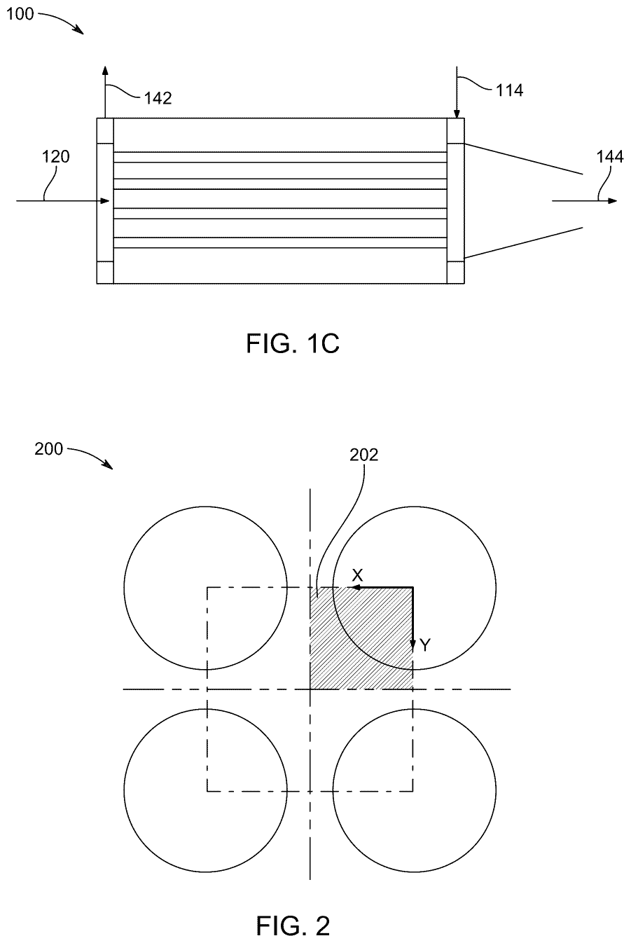

FIG. 1A shows a block diagram of a membrane reactor (MR) system 100, according to certain embodiments. In one embodiment, a casing 136 defines an enclosed space that includes a plurality of tubes 114. The enclosed space is configured to permit heating of a gaseous mixture at temperatures up to 1000 K, preferably 600-1000 K, preferably 700-950 K, preferably 800-900 K and pressures up to 40 bars, preferably 5-35 bars, preferably 10-30 bars, preferably 15-25 bars. A porous tube or set of porous tubes includes a porous shell (e.g., 104) comprising a steam-methane reforming catalyst 110. The porous tube or set of porous tubes functions to provide a reactor environment whereby a feed gas is reformed to produce a gaseous product that comprises hydrogen. A permeation tube or set of permeation tubes (e.g., 114) is also present in the enclosed space. The permeation tubes function to separate hydrogen from the gaseous product that is formed during the reformation of the feed gas in the porous tubes.

The MR system 100 includes an enclosure 102. The enclosure 102 includes a shell 104, a front cap 106, and a back cap 108. The shell 104 is porous and includes a steam-methane reforming (SMR) catalyst 110. The SMR catalyst 110 is composed of a nickel aluminum oxide alloy including 20-40 wt. %, preferably 25-35 wt. %, preferably about 30 wt. % of nickel based on a total weight of the nickel aluminum oxide alloy. The nickel aluminum oxide alloy has a bed porosity of 0.2-0.6, preferably 0.3-0.5, preferably about 0.4. Furthermore, the nickel aluminum oxide alloy has an average particle diameter of 2.5-4.5 mm, preferably 3.0-4.0 mm, preferably about 3.5 mm, and a catalyst density of 2000-2700 kg/m3, preferably 2200-2500 kg/m3,preferably about 2350 kg/m³. Table 1 describes the properties of the shell 104.

TABLE 1
Properties of the shell 104 (porous media) of the MR system 100

| Material | 30% Ni/Al₂O₃ | |
|---|---|---|
| Particle diameter (D_{P}) | 3.5 mm (average) | |
| Catalyst density (ρ_{c}) | 2355.3 | kg/m³ |
| Bed porosity (γ) | 0.4 | |
| Effective radial diffusion | 0.2109 | m²/h |
| coefficient | | |
| Effective radial thermal | 0.432 | W/m²/K |
| conductivity | | |

| | |
|---|---|
| Ergun Friction factor | 44.37 |

The MR system 100 further includes a feed inlet 112 connected to the enclosure 102. The feed inlet 112 is configured to receive a feed gas comprising CH₄ and H₂O to produce H₂ catalyzed by the SMR catalyst 110 of the shell 104. The feed gas can further include carbon oxide and hydrogen. In FIG. 1B, a feed gas 132 received by the feed inlet 112 is inside the shell 104 or the casing 136 while being outside the Pd—Ag membrane 118. As a result, the feed gas 132 can be catalyzed by the SMR catalyst 110 of the shell 104 to produce H₂ which then permeates through the Pd—Ag membrane 118. In this aspect the feed gas 132 directly enters only the interior of the porous tubes (e.g., 104) and is preferably not directly fed into the permeation tubes (e.g. 114) and/or the portion of the enclosed space outside the porous tubes.

The MR system 100 also includes a tube 114. The tube 114 is disposed inside the enclosure 102. The shell 104 is spaced apart from the tube 114 with no SMR catalyst in between. The tube 114 has a sidewall 116 defining a feed side and a sweep side. The feed side is connected to the feed inlet 112. The sidewall 116 includes a palladium silver (Pd—Ag) membrane 118 configured to selectively permeate the H₂ from the feed side to the sweep side. The MR system 100 includes a sweep inlet 120 connected to the sweep side. The sidewall 116 of the tube 114 includes Inconel to support the Pd—Ag membrane 118. Table 2 describes the specifications of the Pd—Ag membrane 118.

TABLE 2
Specifications of the Pd-Ag membrane 118

| | Pd-Ag film (Inconel- | |
|---|---|---|
| Material | supported) | |
| Diameter | 17 | mm |
| Thickness | 10 | μm |
| Length | 0.5 | m |
| Density | 11000 | kg/m³ |
| Specific heat (Cₚ) | 240 | J/kg/K |
| Thermal conductivity | 71.8 | W/m/K |

The sweep inlet 120 is configured to receive a sweep gas to carry and transport the H₂. The sweep gas includes water steam (H₂O) of fixed flow rate. The water steam is pre-heated to 600-1000 K, preferably 700-950 K, preferably 800-900 K before it is received by the sweep inlet 120. In an implementation, the feed inlet 112 and the sweep inlet 120 are both connected to the front cap 106 or both connected to the back cap 108 so that the feed gas and the sweep gas are configured to flow in a same direction in the shell 104. In some implementations, one of the feed inlet 112 and the sweep inlet 120 is connected to the front cap 106 while the other one of the feed inlet 112 and the sweep inlet 120 is connected to the back cap 108 so that the feed gas and the sweep gas are configured to flow in different or opposite directions in the shell 104. In some examples, the shell 104 is longer than the Pd—Ag membrane 118 along a longitudinal direction of the shell 104. The feed inlet 112 is offset from the Pd—Ag membrane 118 along the longitudinal direction of the shell 104 so that the feed gas is configured to produce the H₂ before getting into contact with the Pd—Ag membrane 118.

The MR system 100 can include a plurality of tubes, and the plurality of tubes are arranged in a square pattern (see e.g. FIG. 2). Further, the plurality of tubes has a smaller diameter that result in a very small diameter ratio with respect to the shell diameter. In an example, each tube has a diameter of 10-20 millimeters, preferably 13-17 mm, preferably about 15 mm, a thickness of 5-20 micrometers, preferably 10-15 micrometers, preferably 17-18 micrometers, and a length of 0.25-1.0 meter, preferably 0.50-0.75 meter, preferably 0.6-0.7 meter. Further, the neighboring tubes have a spacing of less than 22 mm, preferably 5-20 mm, preferably 10-15 mm. The MR system 100 further includes a production outlet connected to the tube 114. The production outlet is configured to discharge the sweep gas and the H₂. The MR system 100 also includes a retentate outlet connected to the enclosure 102. The retentate outlet is configured to discharge the feed gas.

FIG. 1B shows a cross-sectional view of the MR system 100, according to certain embodiments. In FIG. 1B, the Pd—Ag membrane 118 is shown. Reference numeral “132” represents the feed gas including CH₄, H₂O, CO₂, and H₂. Further, reference numeral “134” represents the sweep gas including the water stream (i.e., H₂O), and permeated H₂. Reference numeral “136” represents the casing.

FIG. 1C shows another view of the MR system 100, according to certain embodiments. In FIG. 1C, the feed inlet 114 is shown. The sweep inlet 120, a retentate outlet 142, and a production outlet 144 are also shown in FIG. 1C. The feed inlet 114 is configured to receive the feed gas including CH₄, H₂O, CO₂, and H₂. The sweep inlet 120 is configured to receive the sweep gas including the water stream. The retentate outlet 142 is configured to discharge the feed gas. The production outlet 144 is configured to discharge the sweep gas and the H₂.

In one aspect of the present disclosure, the operating conditions of the MR system 100 are described according to a three-dimensional (3D) numerical simulation for hydrogen production on a commercial scale that was conducted in two processes. In the first process, the 3D numerical simulation was carried out under the conditions of non-reforming reactions, focusing solely on H₂ separation only. This process was aimed at identifying the operating conditions to achieve the desirable (highest) H₂ permeation rate and a minimum size of the MR system 100. After describing the MR system from the previous process (i.e., the first process), in the second process, additional simulations were performed. These simulations activated the reforming reactions to examine the overall hydrogen production process under the optimized conditions.

As previously described, the MR system 100 can include multiple tubes arranged in a square pattern. For numerical simulations, one square arrangement containing four adjacent tubes was considered. Referring to FIG. 2, a schematic representation 200 of an integration domain for numerical calculations (hatched area, represented by reference numeral “202”) in X-Y plane, extended in the Z-direction for the entire length of the MR system 100 is described. To reduce computational complexity due to symmetry, the integration domain for numerical calculations can be further reduced to one quarter of any four adjacent tubes along the entire length of the MR system 100.

The operating conditions of the MR system 100 were set to achieve the highest H₂permeation rate while keeping the length of the MR system 100 fixed at 0.5 m. The tubes in the MR system 100 have a diameter of 17 mm, and pitch distance between each two adjacent tubes (between the center lines) is 22 mm. The size of the each tube was determined based on the allowable limit of pressure drop within the tube while providing a better surface area to volume ratio. Reducing the tube diameter may result in a higher permeation flux and a more compact MR system 100. However, there is a limitation to reducing the tube diameter, as it affects the allowable viscous pressure drop within the tube.

The effects of various factors on H₂ permeation characteristics were investigated, including the feed mixture composition, feed pressure, inlet gas temperature, and flow configuration (co-current vs. counter-current). For this purpose, different simulation cases were performed as per the operating conditions listed in Table 3. The selected temperature range (400-600° C.) for the simulations was based on the operability limits of the MR system 100 for the SMR to produce H₂. The feed gas concentrations were selected based on the anticipated percentage of methane conversion in the actual SMR process. The feed and sweep flow rates were calculated based on average H₂ permeation rate.

TABLE 3
Operating conditions of different simulation cases for
study under non-reforming (separation only) conditions

| | case | | | | | | | | |
|---|---|---|---|---|---|---|---|---|---|
| | | 2 | | | | | | | |
| Parameter | 1 | (base) | 3 | 4 | 5 | 6 | 7 | 8 | 9 |
| Reactivity | Non-reforming | | | | | | | | Reforming |
| Sweep gas | 1.43114 × 10⁻⁴ | | | | | | | | |
| flow rate | | | | | | | | | |
| (H₂O) [kg/s] | | | | | | | | | |
| Feed gas flow | 1.233591 × 10⁻³ | | | | | | | | |
| rate [kg/s] | | | | | | | | | |
| Flow | Counter- | Co-current | | | | | | | |
| configuration | current | | | | | | | | |
| Isothermal | 800 | | | | | | 900 | 700 | 800 |
| reactor | | | | | | | | | |
| temperature [K] | | | | | | | | | |
| Feed pressure | 9 | | 15 | 30 | 9 | | | | |
| [bar] | | | | | | | | | |
| Feed gas | 5% CH₄ | | | | 10% CH₄ | 0% CH₄ | 5% CH₄ | | 25% CH₄ |
| concentrations | 20% H₂O | | | | 25% H₂O | 0% H₂O | 20% H₂O | | 75% H₂O |
| (by volume) | 15% CO₂ | | | | 20% CO₂ | 25% CO₂ | 15% CO₂ | | |
| | 60% H₂ | | | | 45% H₂ | 75% H₂ | 60% H₂ | | |
| Pitch [mm] | 22 | | | | | | | | |
| Tube diameter | 17 | | | | | | | | |
| [mm] | | | | | | | | | |
| Membrane | 0.5 | | | | | | | | |
| Reactor length | | | | | | | | | |
| [m] | | | | | | | | | |

To mimic the real case of SMR, the feed shell zone was considered porous in all simulations. In the industrial-scale design of the membrane unit for H₂ production, the pressure drop may be high due to the presence of the tightly packed catalytic particles. To calculate the pressure drop (ΔP) within the porous zone, the semi-empirical Ergun formula was implemented as follows:

$$\frac{Δ P}{L} = \frac{150 {μ}_{f}}{{D}_{P}^{2}} \frac{{( 1 - γ )}^{2}}{{γ}^{3}} \vec{U} + \frac{1.75 {ρ}_{c} ( 1 - γ )}{{D}_{P} {γ}^{3}} {\vec{U}}^{2} \qquad ( 1 )$$

where, the parameters L, γ, and pc represent depth, bed porosity, and density of the porous media, respectively. The parameters μ_{f} and U represent viscosity and bulk velocity of the fluid, respectively. The term

$$\frac{150 {μ}_{f}}{{D}_{P}^{2}} \frac{{( 1 - γ )}^{2}}{{γ}^{3}}$$

represents the coefficient of viscous resistance and the term

$$\frac{1.75 {ρ}_{c} ( 1 - γ )}{{D}_{P} {γ}^{3}}$$

represents the coefficient of inertial resistance. The two coefficients were defined along two directional vectors in X and Y directions. The commercially available 30% Ni/Al₂O₃ catalyst was considered as per the properties listed in Table 1.

The feed side is separated from the sweep side using Pd—Ag membrane tubes. The Pd—Ag membrane tubes are selective for H₂ to be separated from the feed side to the shell side depending on the operating temperature and partial pressure difference of H₂ between the feed side and the shell side. The rate of H₂ permeation flux (J_{H2}) is calculated in mol/m²/s based on the Sievert's law as follows:

$${J}_{H 2} = \frac{{P}_{MO}}{{δ}_{H 2}} exp ( \frac{- {E}_{H 2}}{RT} ) ( \sqrt{{P}_{H 2}^{F . S}} - \sqrt{{P}_{H 2}^{P . S}} ) \qquad ( 2 )$$

where, P_{MO} is the pre-exponential coefficient for permeation (for example, 0.00207 mol.m/m²/min/atm^{0.5}), δ_{H2} is the membrane thickness, and E_{H2} is the required activation energy for H₂ permeation (for example, 9180 J/mol). P_{H2}^{F.S} and P_{H2}^{P.S} are the partial pressures of H₂ in the feed side and the shell side (interchangeably referred to as permeate side) of the membrane, respectively.

In the simulations performed using ANSYS Fluent software version 2020-R1, the full 3D domain of the selected integration zone of the MR system 100 was considered. The software solved the governing equations, which included mass, energy, momentum, and species transport equations, in the 3D domain. The equations are modified to account for the presence of the porous media of the shell 104 and H₂ permeation from the feed side to the sweep side across the Pd—Ag membrane 118. In these simulations, the Pd—Ag membrane 118 was treated as a wall that allowed for heat exchange with the medium but did not allow for mass transfer. To account for the transfer of H₂ from the feed side to the sweep side, a source/sink term (Sᵢ) was introduced in both the mass and momentum equations. The term Sᵢ had a negative sign (source) in the feed side and a positive sign (sink) in the shell side. This term Sᵢ can be expressed in kg/m³/s using H₂ permeation flux, cell area (A_{C}), cell volume (V_{C}), and the molecular weight of H₂ (MW_{H2}) as follows:

$${S}_{i} = \pm \frac{{J}_{H 2} \cdot {A}_{c \cdot } {MW}_{H 2}}{{V}_{c}} \qquad ( 3 )$$

A series of user-defined functions (UDFs), written in visual C++, were developed, attached, and hooked to the Fluent software. The additional UDFs were integrated with the software through coupling the Fluent software with Microsoft visual studio 2013. In all simulations, the catalytic bed (see Table 1) in the shell side was assumed pseudo-homogeneous to be solved as a continuum. The modified governing equations to account for the porous media and H₂ permeation including, mass, energy, momentum, and species transport can be expressed as follows:

$$∇ \cdot ( {γρ}_{f} \vec{U} ) = {S}_{i} \qquad ( 4 )$$

$$∇ \cdot ( {ρ}_{f} \vec{U} \vec{U} ) = - ∇ P + \frac{Δ P}{L} \vec{U} + ∇ \cdot \vec{τ} + {ρ}_{f} \vec{g} \qquad ( 5 )$$

$$∇ \cdot ( {ρ}_{f} \vec{U} h + \vec{U} P ) = ∇ \cdot ( {k}_{e} ∇ T - {\sum }_{i} {h}_{i} {j}_{i} + \vec{τ} \cdot \vec{U} ) + ( 1 - γ ) {ρ}_{c} {\sum }_{j} Δ {H}_{j} {R}_{j} \qquad ( 6 )$$

$$∇ \cdot ( {γρ}_{f} \vec{U} {x}_{i} ) = ∇ \cdot ( {ρ}_{f} {D}_{i , e} ∇ {x}_{i} ) + ( 1 - γ ) {ρ}_{c} {M}_{i} {\sum }_{j} {α}_{ij} {R}_{j} + {S}_{i} \qquad ( 7 )$$

where, xᵢ is the mass fraction of a given species i, Rⱼ is the rate of reaction, and αᵢⱼ is the stoichiometric coefficient of a given species i in a given reaction j. The term Rⱼ was assigned a value of zero in both the porous shell side and of course in the tube side, as only flow field is solved without considering the reforming reactions. The term Sᵢ is limited only to the domain cells in contact with the membrane wall from both sides and to the H₂ molecules only, and it has a value of zero elsewhere and for other species. The bed porosity y in the permeation zone was assigned a value of 1.0 as there is no catalyst. The term \vec{τ} is the viscous stress tensor, P is the pressure, Tis the temperature, Mᵢ is the molecular weight of a given species i, kₑ is the effective thermal conductivity, D_{i,e} is the effective diffusion coefficient of a given species i, and hᵢ is the specific enthalpy of a given species i.

For the simulations considering reforming reactions, the model developed by Rodriguez et al. (See: Rodriguez et al., “Two-dimensional modeling of a membrane reactor for ATR of methane”. Catalysis Today 193 (2012) 137-144, incorporated herein by reference in its entirety) for SMR was used. The considered reforming reactions of methane are expressed as follows with the reaction rates expressions as listed in Tables 4.

CH₄+H₂O⇄CO+3 H₂ [ΔH°]_298=−206 KJ/mol (8)

CO+H₂O⇄CO₂+H₂ [ΔH°]_298=−41 KJ/mol (9)

CH₄+2H₂O⇄CO₂+4 H₂[ΔH°]_298=165 KJ/mol (10)

TABLE 4
Reaction rates expressions for SMR

| Reaction number | Reaction rate equation |
|---|---|
| r₁ | $\frac{{k}_{1} / {P}_{{H}_{2}}^{2.5} ( {P}_{CH 4} {P}_{H 2 O} - {P}_{{H}_{2}}^{3} {P}_{CO} / {k}_{eq , 1} )}{{( 1 + {K}_{CO} {P}_{CO} + {K}_{H 2} {P}_{H 2} + {K}_{CH 4} {P}_{CH 4} + \frac{{K}_{H 2 O} {P}_{H 2 O}}{{P}_{H 2}} )}^{2}}$ |
| r₂ | $\frac{( {k}_{2} / {P}_{{H}_{2}} ( {P}_{CO} {P}_{H 2 O} - {P}_{H 2} {P}_{CO 2} / {k}_{eq , 2} )}{{( 1 + {K}_{CO} {P}_{CO} + {K}_{H 2} {P}_{H 2} + {K}_{CH 4} {P}_{CH 4} + \frac{{K}_{H 2 O} {P}_{H 2 O}}{{P}_{H 2}} )}^{2}}$ |
| r₃ | $\frac{{k}_{3} / {P}_{{H}_{2}}^{3.5} ( {P}_{CH 4} {P}_{{H}_{2 O}}^{2} - {P}_{{H}_{2}}^{4} {P}_{CO 2} / {k}_{eq , 3} )}{{( 1 + {K}_{CO} {P}_{CO} + {K}_{H 2} {P}_{H 2} + {K}_{CH 4} {P}_{CH 4} + \frac{{K}_{H 2 O} {P}_{H 2 O}}{{P}_{H 2}} )}^{2}}$ |

TABLE 5
Kinetic parameters of SMR reactions (kᵢ = Aᵢ exp (−Ea/RT))

| | Pre- | | |
|---|---|---|---|
| | exponential | | |
| | coefficient, | | Activation energy, |
| kᵢ | Aᵢ | Unit | Eaᵢ (kJ/mol) |
| k₁ | 3.66 × 10¹⁴ | (kmol Pa^{0.5})/(kg_{cat} s) | 240.1 |
| k₂ | 5.41 × 10⁻³ | (kmol Pa⁻¹)/(kg_{cat} s) | 67.1 |
| k₃ | 8.83 × 10¹³ | (kmol Pa^{0.5})/(kg_{cat} s) | 243.9 |

TABLE 6
Adsorption parameters of reactions for steam reforming
of methane (Kⱼ = Aⱼ exp (−ΔHj/RT))

| | Pre- | | |
|---|---|---|---|
| | eponential | | |
| | coefficient, | | |
| Kⱼ | Aⱼ | Unit | ΔHj, (kJ/mol) |
| K_{CH4} | 6.65 × 10⁻⁹ | Pa⁻¹ | −38.3 |
| K_{CO} | 8.231 × 10⁻¹⁰ | Pa⁻¹ | −70.7 |
| K_{H2} | 6.12 × 10⁻¹⁴ | Pa⁻¹ | −82.9 |
| K_{H2O} | 1.77 × 10⁵ | — | 88.7 |

TABLE 7
Equilibrium constants of SMR reactions

| K_{eg} | unit | Expression |
|---|---|---|
| k_{eq,1} | Pa² | $1.02667 \times {10}^{10} e ( - \frac{2683}{T} + 30.11 )$ |
| k_{eq,2} | — | ${e}^{( \frac{4400}{T} - 4.063 )}$ |
| k_{eq,3} | Pa² | k_{eq,1} × k_{eq,2} |

The parameters P_{CH4}, P_{H2}, P_{H2O}, P_{CO}, and P_{CO2} represent the partial pressures of CH₄, H₂, H₂O, CO, and CO₂, respectively, while the parameters k₁, k₂, and k₃ represent the rate coefficients of the reforming reactions (as described in Table 5) with K_{CO}, K_{H2}, and K_{CH4} representing the adsorption constants of CO, H₂, and CH₄, respectively and K_{H2O} representing the sociative adsorption constant of H₂O (as described in Table 6). The coefficients k_{eq,1}, k_{eq,2}, and k_{eq,3} represent the equilibrium constants of the SMR reactions (as described in Table 7). The reaction rates are multiplied by a factor of 0.1 to account for internal and external diffusion resistance caused by the catalytic porous media in the shell side. UDFs have been developed in C++, hooked, and compiled with the fluent software to solve for the rates of reforming reactions.

Mass flow rate inlet boundary conditions were considered at the feed inlet (for example, the feed inlet 112) and the sweep inlet (for example, the sweep inlet 120) with an elevated inlet temperature. In all simulations, the pressure at the sweep side was considered atmospheric and the pressure at the feed side was varied as per the values listed in Table 3. At retentate outlet (for example, the retentate outlet 142) and production outlet (for example, the production outlet 144), pressure outlet boundary conditions were assigned at the outlet pressure equal to the operating pressure in each side, with backflow conditions of normal air at the operating temperature. Coupled thermal boundary conditions were considered at the membrane walls from both sides, and the MR system 100 was considered isothermal with symmetrical boundary conditions applied to all its outer sides. Three meshes were constructed for the 3D integration domain, having a different number of cells of 39,960, 168,600, and 281,000. A mesh independence study was performed by running the simulations under the conditions of case 2 (base), as indicated in Table 3, and H₂ permeation flux was determined for the three meshes. The mesh of 39,960 cells resulted in a significant difference in H₂ flux compared to the other two meshes. The mesh of 168,000 cells resulted in almost identical results, with a difference of less than 1% difference, like the mesh of 181,000 cells but in significantly less calculation time. Based on that, the mesh of 168,600 cells was selected to perform all simulations for the present study. A semi-implicit double-precision solver was used for the coupling between pressure and velocity. The gas mixture properties, including viscosity and thermal conductivity, were calculated as mass-weighted average of all mixture species. Different polynomial fits as functions of temperature were used to calculate the specific heat of the different species. To ensure convergence criteria, the advanced multi-grid (AMG) solver was used with precise under relaxation factors for the different parameters. The solution was considered converged when the summation of all residuals falls below a set value, 10⁻⁶. The computational fluid dynamics (CFD) model used in this study, including the permeation model using UDFs, was validated several times with and without volumetric reactions and proved very good agreement with the experimentally recorded permeation flux data.

For simulation results, the inlet section of the MR system 100 is located at an axial distance of Z=0.5 m, where all gases are fed into the MR system 100, and the gases exit from the exit section at Z=0.0 m. For the counter-current flow configuration case, only the direction of sweeping H₂O is reversed, with gases being at Z=0.0 and leaving at Z=0.5 m. The axial distributions of the different parameters for the various cases under investigation are presented in terms of normalized reactor length, where values of 1.0 and 0.0 indicate the inlet and outlet sections, respectively. Firstly, the results of the study of reactor flow and design parameters are presented considering non-reforming conditions. This is done to isolate its effect, with only gas mixing and hydrogen separation being taken into account. The concentrations of inlet gases to the shell side of the MR system 100 are based on achievable reforming process gases that need to undergo further processing for hydrogen separation. Subsequently, the combination of fuel reforming and hydrogen separation is considered for the optimized case to investigate the performance of the MR system 100 under SMR conditions.

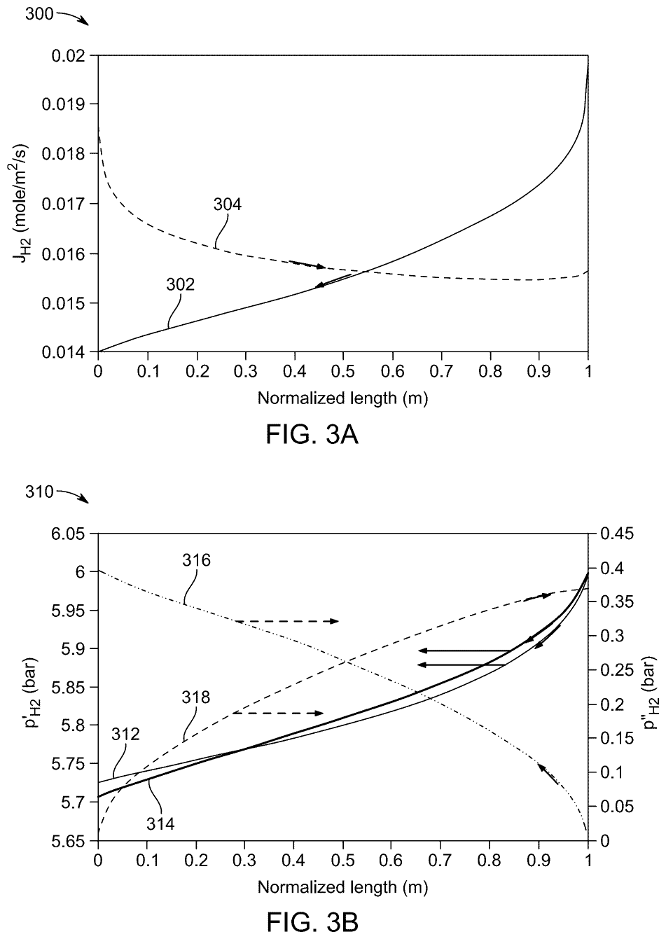

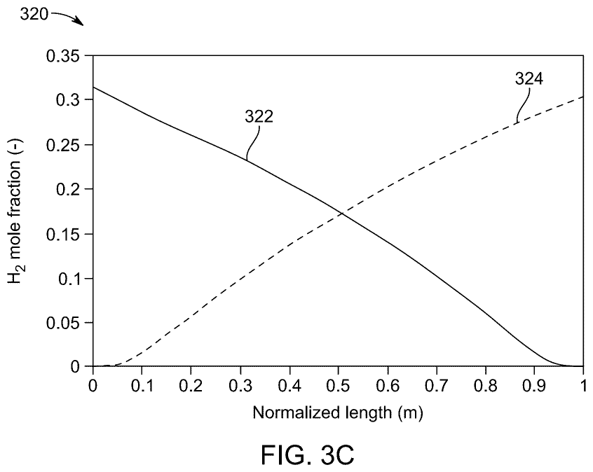

FIG. 3A shows a plot 300 illustrating comparison of counter-current flow configuration and co-current flow configuration in terms of axial distributions of hydrogen permeation flux, according to certain embodiments. In the plot 300, the plot line 302 represents the co-current flow configuration of the hydrogen permeation flux and the plot line 304 represents the counter-current flow configuration of the hydrogen permeation flux.

FIG. 3B shows a plot 310 illustrating comparison of counter-current flow configuration and co-current flow configuration in terms of axial distributions of hydrogen partial pressure on both sides of the membrane (P′_{H2} for the feed side and P″_{H2} for the shell side), according to certain embodiments. In the plot 310, the plot line 312 represents the co-current flow configuration for the hydrogen partial pressure of the feed side (P′_{H2}), the plot line 314 represents the counter-current flow configuration for the hydrogen partial pressure of the feed side (P′_{H2}), the plot line 316 represents the co-current flow configuration for the hydrogen partial pressure of the shell side (P″_{H2}), and the plot line 318 represents the counter-current flow configuration for the hydrogen partial pressure of the shell side (P″_{H2}).

FIG. 3C shows a plot 320 illustrating comparison of counter-current flow configuration and co-current flow configuration in terms of axial distributions of averaged mole fraction of hydrogen in the shell side, according to certain embodiments. In the plot 320, the plot line 322 represents the co-current flow configuration of the averaged mole fraction of hydrogen in the shell side and the plot line 324 represents the counter-current flow configuration of the averaged mole fraction of hydrogen in the shell side. The arrows on the plot lines of FIG. 3A, FIG. 3B, and FIG. 3C represent the flow direction from the inlet to the outlet.

Based on equation (2), the hydrogen permeation flux is mainly function of hydrogen partial pressure and membrane temperature. In the given scenario, as the inlet temperature is the same (800 K) and the reforming reactions are not activated for both co-current flow configuration and counter-current flow configuration, the temperature effect on varying the hydrogen permeation flux may be insignificant. Instead, the dominant factor is the hydrogen partial pressure distribution.

In the co-current flow configuration, there are higher partial pressure differences near the inlet of the MR system 100, leading to a peak in hydrogen permeation flux (as depicted in FIG. 3A, FIG. 3B, and FIG. 3C). As the flow progresses axially, the hydrogen partial pressure decreases on the feed side and increases on the sweep side, resulting in a reduction in the partial pressure difference across the membrane and consequently lowering the hydrogen permeation flux. On the other hand, in the counter-current flow configuration, the hydrogen partial pressure difference remains almost uniform along the entire length of the MR system 100 due to the reversal of direction of the sweep inlet 120. This results in a peak in hydrogen permeation flux near the sweep inlet 120, and the curve remains relatively flat throughout the length of the MR system 100. Comparing the two flow configurations, the co-current flow configuration exhibits a higher peak in hydrogen permeation flux due to the higher differences in hydrogen partial pressure. As a consequence, the co-current flow configuration also leads to a higher hydrogen mole fraction at the exit section of the MR system 100 compared to the counter-current flow configuration (as shown in FIG. 3A, FIG. 3B, and FIG. 3C). Additionally, the effective heat transfer in the counter-current flow configuration causes a slight drop in membrane temperature, resulting in a lower hydrogen permeation flux compared to the co-current flow configuration.

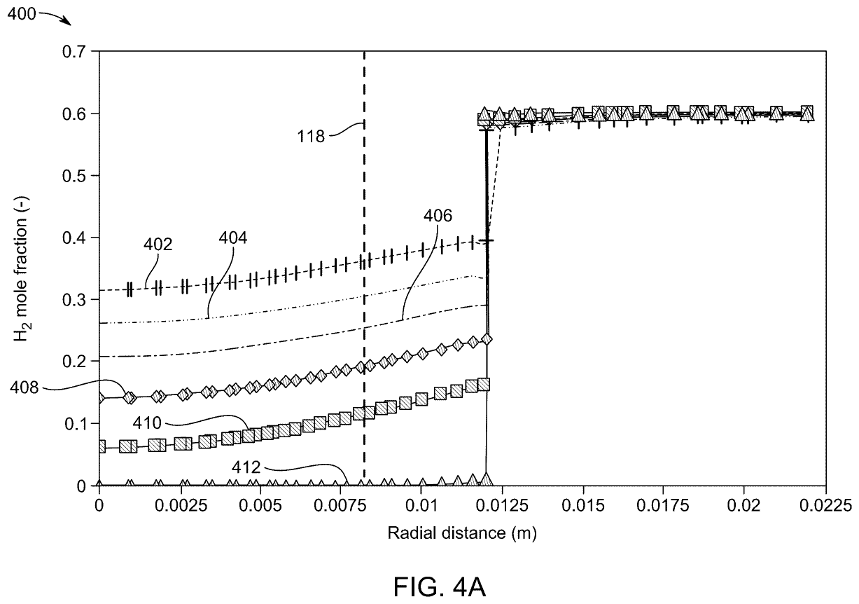

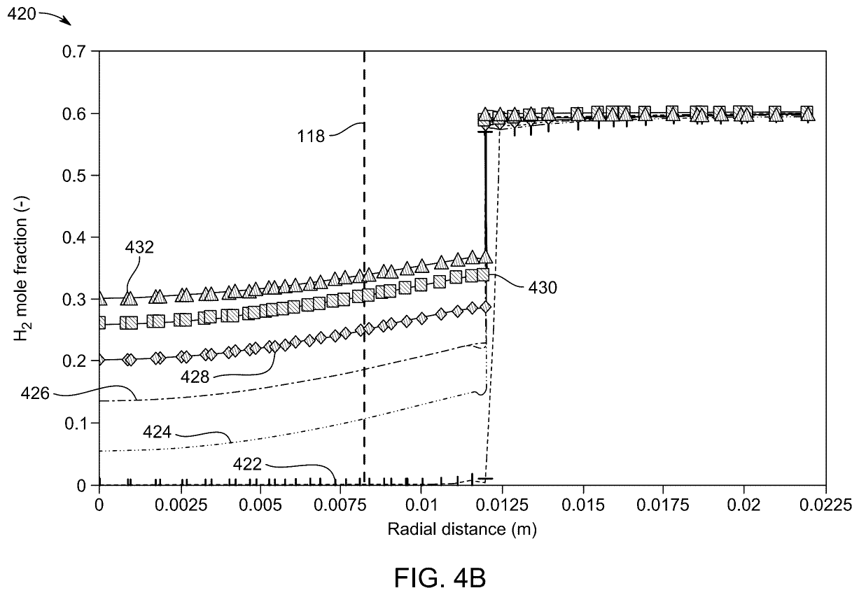

FIG. 4A shows a plot 400 illustrating the co-current flow configuration in terms of radial distributions of hydrogen mole fraction at different axial locations on an axial plane inclined by 45° (X-Y), and crossing the centerline of the Pd—Ag membrane 118, according to certain embodiments. In plot 400, plot line 402 represents the co-current flow configuration in terms of radial distributions of hydrogen mole fraction at axial location Z=0.0 m, plot line 404 represents the co-current flow configuration in terms of radial distributions of hydrogen mole fraction at axial location Z=0.1 m, plot line 406 represents the co-current flow configuration in terms of radial distributions of hydrogen mole fraction at axial location Z=0.2 m, plot line 408 represents the co-current flow configuration in terms of radial distributions of hydrogen mole fraction at axial location Z=0.3 m, plot line 410 represents the co-current flow configuration in terms of radial distributions of hydrogen mole fraction at axial location Z=0.4 m, and plot line 412 represents the co-current flow configuration in terms of radial distributions of hydrogen mole fraction at axial location Z=0.5 m.

FIG. 4B shows a plot 420 illustrating the counter-current flow configuration in terms of radial distributions of hydrogen mole fraction at different axial locations on an axial plane inclined by 45° (X-Y), and crossing the centerline of the Pd—Ag membrane 118, according to certain embodiments. In plot 420, plot line 422 represents the counter-current flow configuration in terms of radial distributions of hydrogen mole fraction at axial location Z=0.0 m, plot line 424 represents the counter-current flow configuration in terms of radial distributions of hydrogen mole fraction at axial location Z=0.1 m, plot line 426 represents the counter-current flow configuration in terms of radial distributions of hydrogen mole fraction at axial location Z=0.2 m, plot line 428 represents the counter-current flow configuration in terms of radial distributions of hydrogen mole fraction at axial location Z=0.3 m, plot line 430 represents the counter-current flow configuration in terms of radial distributions of hydrogen mole fraction at axial location Z=0.4 m, and plot line 432 represents the counter-current flow configuration in terms of radial distributions of hydrogen mole fraction at axial location Z=0.5 m.

In FIG. 4A and FIG. 4B, the radial distributions of hydrogen mole fraction on an inclined axial plane crossing the centerline of the Pd—Ag membrane 118. These results indicate that the co-current flow configuration exhibits better development with higher values of hydrogen mole fractions from the inlet to the outlet of the MR system 100. In both flow configurations, only a limited region near the Pd—Ag membrane 118 of the feed side is affected by hydrogen permeation. This is evident from the sudden drop in hydrogen mole fraction at specific radial distances (0.0124 m for counter-current flow configuration and 0.0120 m for co-current flow configuration) as depicted in FIG. 4A and FIG. 4B.

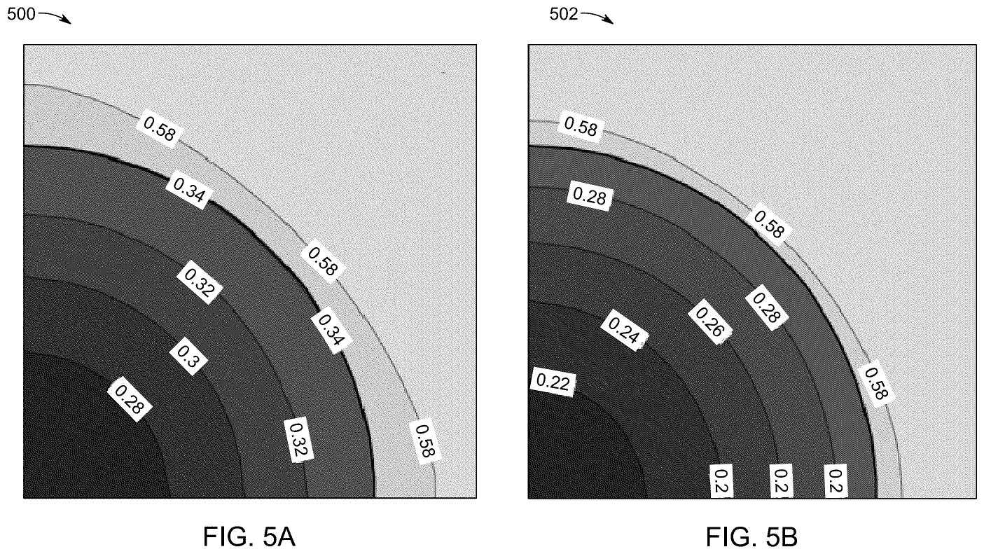

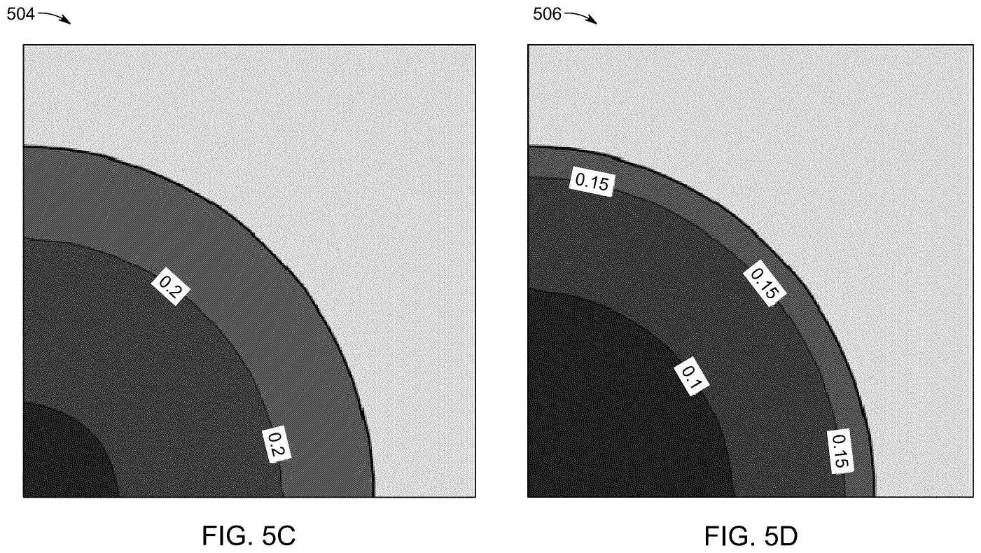

FIG. 5A shows a two-dimensional (2D) contour plot 500 of hydrogen mole fraction on X-Y planes at axial location of Z=0.1 m for the base case (case 2) of co-current flow configuration, according to certain embodiments. FIG. 5B shows a 2D contour plot 502 of hydrogen mole fraction on X-Y planes at axial location of Z=0.2 m for the base case (case 2) of co-current flow configuration, according to certain embodiments. FIG. 5C shows a 2D contour plot 504 of hydrogen mole fraction on X-Y planes at axial location of Z=0.3 m for the base case (case 2) of co-current flow configuration, according to certain embodiments. FIG. 5D shows a 2D contour plot 506 of hydrogen mole fraction on X-Y planes at axial location of Z=0.4 m for the base case (case 2) of co-current flow configuration, according to certain embodiments. The contour plots 500, 502, 504, and 506, representing hydrogen mole fraction at different axial locations on planes normal to the flow direction, also support the findings of FIG. 4A and FIG. 4B. Hydrogen permeation is confined to a zone near the Pd—Ag membrane 118 in the feed side and does not cover the entire feed side domain. However, the effect of hydrogen permeation influences the entire domain within the Pd—Ag membrane 118, leading to significant changes in the hydrogen mole fraction distributions.

Based on this comparison between the counter-current flow configuration and the co-current flow configuration, it is concluded that the co-current flow configuration results in better development of hydrogen mole fractions with higher hydrogen permeation flux. Consequently, the co-current flow configuration is recommended for optimizing flow and design parameters of the MR system 100. This can be achieved by reducing the volume of the reactor shell side to match the size of membrane tubes by reducing the pitch distance between membrane tubes without altering the size of the membrane tubes themselves.

The feed and sweep flow rates were determined to achieve operable conditions of flow velocity and viscous pressure drop. To achieve the desired hydrogen production rate from the reforming process on the feed side, the required membrane surface area for complete hydrogen separation was calculated. The surface area to volume ratio of the membrane tube is a crucial parameter in designing the MR system 100. Increasing the surface area would result in a larger size of the MR system 100, which may not be desirable from operational and economic perspectives. The membrane tube diameter plays a key role in determining various factors such as hydrogen permeation flux, reactor size, heat transfer, and pressure drop. For the same inlet gas flow rates, reducing the membrane tube diameter leads to higher flow velocity of the purging gas in the sweep side, which improves the scavenging of the permeated hydrogen. This results in a better area-to-volume ratio and higher hydrogen permeation flux. However, the reduction in membrane tube diameter is limited by the maximum allowable viscous pressure drop inside the membrane tubes. Maintaining an appropriate hydrogen partial pressure in the sweep side allows for higher hydrogen permeation rates. Based on the considered gas flow rates, calculated flow velocities, and allowable viscous pressure drop, a membrane tube diameter of 17 mm was selected. This selection strikes a balance between achieving efficient hydrogen permeation and meeting the constraints of pressure drop within the membrane tubes.

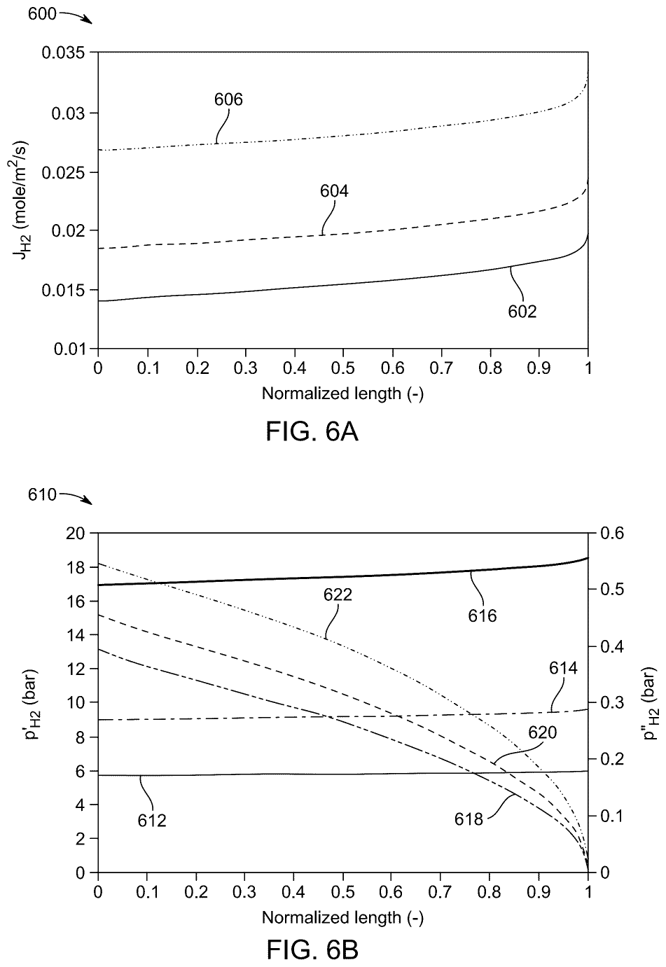

FIG. 6A shows a plot 600 representing an effect of feeding pressure in the membrane feed side on the axial distributions of hydrogen permeation flux on both sides of the membrane, according to certain embodiments. In plot 600, plot line 602 represents an effect of feeding pressure of 9 bars (case 2) in the membrane feed side on the axial distributions of hydrogen permeation flux, plot line 604 represents an effect of feeding pressure of 15 bars (case 3) in the membrane feed side on the axial distributions of hydrogen permeation flux, and plot line 606 represents an effect of feeding pressure of 30 bars (case 4) in the membrane feed side on the axial distributions of hydrogen permeation flux.

FIG. 6B shows a plot 610 representing an effect of feeding pressure in the membrane feed side on the axial distributions of hydrogen partial pressure on both sides of the membrane, according to certain embodiments. In plot 610, plot line 612 represents an effect of feeding pressure of 9 bars (case 2) for the hydrogen partial pressure (P′_{H2}), plot line 614 represents an effect of feeding pressure of 15 bars (case 3) for the hydrogen partial pressure (P′_{H2}), plot line 616 represents an effect of feeding pressure of 30 bars (case 4) for the hydrogen partial pressure (P′_{H2}), plot line 618 represents an effect of feeding pressure of 9 bars (case 2) for the hydrogen partial pressure (P″_{H2}), plot line 620 represents an effect of feeding pressure of 15 bars (case 3) for the hydrogen partial pressure (P″_{H2}), and plot line 622 represents an effect of feeding pressure of 30 bars (case 4) for the hydrogen partial pressure (P″_{H2}).

In fuel reforming reactors, the primary controlling factor for hydrogen permeation flux is the difference in hydrogen partial pressure on both sides of the Pd—Ag membrane 118. Near the inlet of the MR system 100, these differences are high, resulting in a peak in hydrogen permeation flux. However, as the hydrogen partial pressure difference decreases along the axial direction due to hydrogen permeation to the other side of the Pd—Ag membrane 118, the permeation flux degrades, as depicted in FIG. 6A and FIG. 6B. Therefore, increasing the length of the MR system 100 beyond a certain value would lead to a larger reactor size. A reactor length of 0.5 m was selected to achieve full separation of the produced hydrogen from the reforming process on the feed side. Additionally, increasing the operating pressure in the feed side directly affects the hydrogen permeation flux (as described by Equation (2)) by increasing the hydrogen partial pressure in the feed side. This relationship is evident in FIG. 6A and FIG. 6B, where the development of hydrogen permeation flux and hydrogen partial pressure within the MR system 100 is shown for different feed side pressures of 9, 15, and 30 bars.

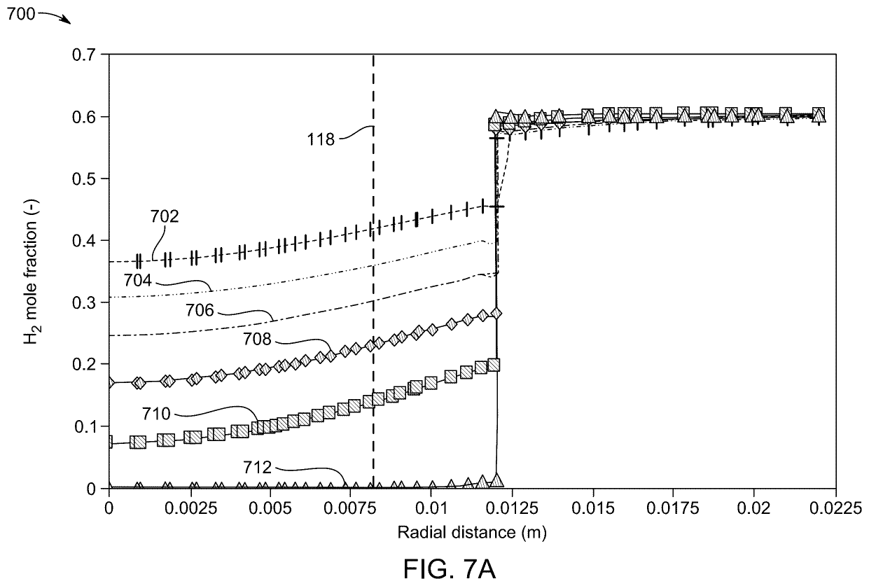

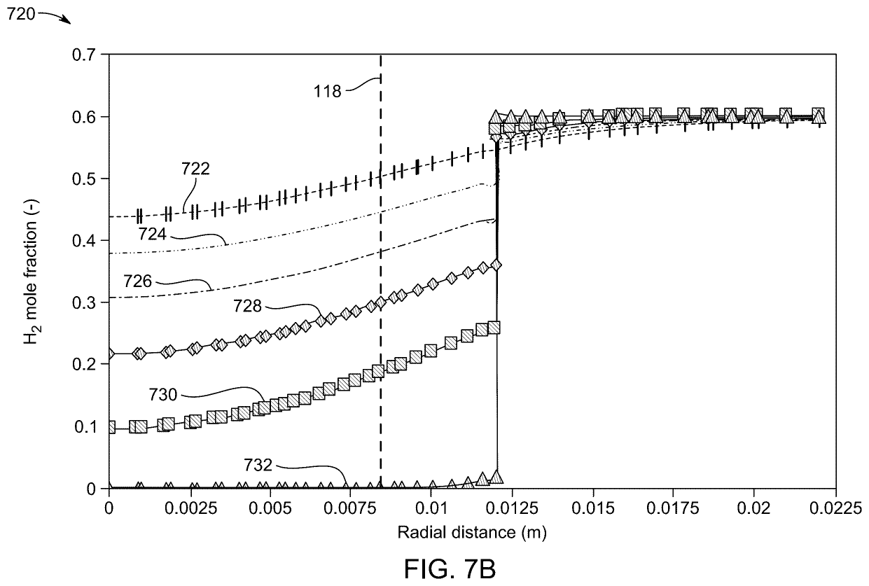

FIG. 7A shows a plot 700 representing an effect of feeding pressure of 15 bars in the feed side on radial distributions of hydrogen mole fraction at different axial locations on an axial plane inclined by 45° (X-Y) and crossing the centerline of the Pd—Ag membrane 118, according to certain embodiments. In plot 700, plot line 702 represents an effect of feeding pressure of 15 bars in the feed side on radial distributions of hydrogen mole fraction at an axial location of Z-0.0 m, plot line 704 represents an effect of feeding pressure of 15 bars in the feed side on radial distributions of hydrogen mole fraction at an axial location of Z=0.1 m, plot line 706 represents an effect of feeding pressure of 15 bars in the feed side on radial distributions of hydrogen mole fraction at an axial location of Z=0.2 m, plot line 708 represents an effect of feeding pressure of 15 bars in the feed side on radial distributions of hydrogen mode fraction at an axial location of Z=0.3 m, plot line 710 represents an effect of feeding pressure of 15 bars in the feed side on radial distributions of hydrogen mole fraction at an axial location of Z=0.4 m, and plot line 712 represents an effect of feeding pressure of 15 bars in the feed side on radial distributions of hydrogen mole fraction at an axial location of Z=0.5 m.

FIG. 7B shows a plot 720 representing an effect of feeding pressure of 30 bars in the feed side on radial distributions of hydrogen mole fraction at different axial locations on an axial plane inclined by 45° (X-Y) and crossing the centerline of the Pd—Ag membrane 118, according to certain embodiments. In plot 720, plot line 722 represents an effect of feeding pressure of 30 bars in the feed side on radial distributions of hydrogen mole fraction at an axial location of Z=0.0 m, plot line 724 represents an effect of feeding pressure of 30 bars in the feed side on radial distributions of hydrogen mole fraction at an axial location of Z=0.1 m, plot line 726 represents an effect of feeding pressure of 30 bars in the feed side on radial distributions of hydrogen mole fraction at an axial location of Z=0.2 m, plot line 728 represents an effect of feeding pressure of 30 bars in the feed side on radial distributions of hydrogen mole fraction at an axial location of Z=0.3 m, plot line 730 represents an effect of feeding pressure of 30 bars in the feed side on radial distributions of hydrogen mole fraction at an axial location of Z=0.4 m, and plot line 732 represents an effect of feeding pressure of 30 bars in the feed side on radial distributions of hydrogen mole fraction at an axial location of Z=0.5 m.

As depicted in FIG. 7A and FIG. 7B, at higher feed pressures, the hydrogen mole fraction develops faster within the MR system 100 due to the higher permeation flux. However, it is observed that only a limited zone in the feed side is affected by the hydrogen permeation process for all feed pressures. The hydrogen mole fraction in all cases remains fixed to the inlet concentration far from the Pd—Ag membrane 118, and there is a sudden drop near the membrane surface due to hydrogen permeation. The radial distance at which this sudden reduction takes place (at 0.0120 m) was found to be unaffected by the pressure in the feed side and remains constant for all feed pressure values.

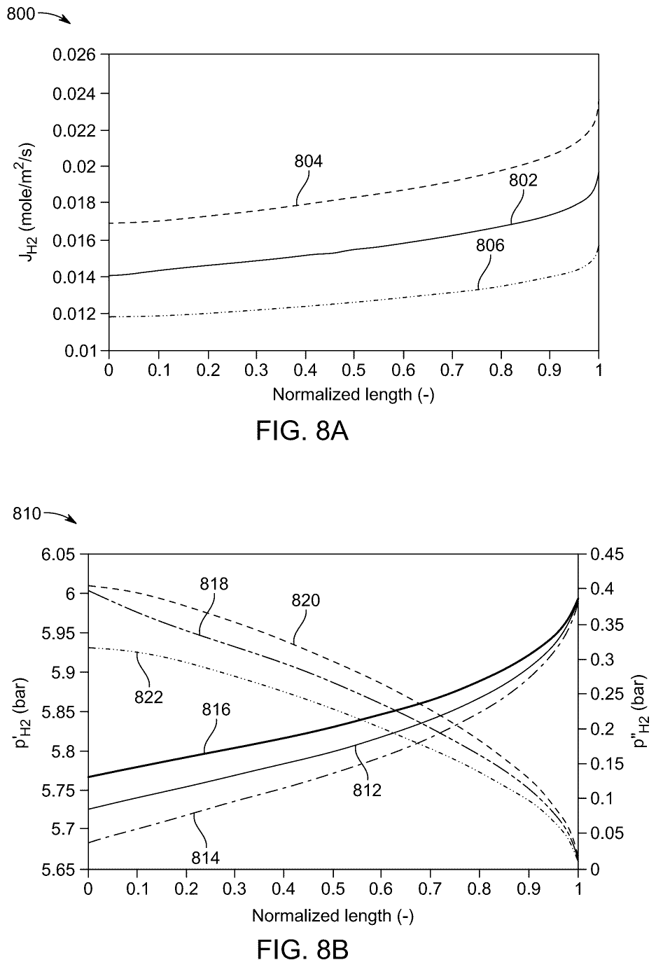

Increasing the temperature for the SMR process by raising the heat input to the MR system 100 results in higher reforming reaction rates, leading to more hydrogen production. Consequently, the membrane surface temperature would also increase, resulting in higher hydrogen separation rates. FIG. 8A shows a plot 800 representing an effect of inlet gas temperature on the hydrogen permeation flux on both sides of the membrane, according to certain embodiments. In plot 800, plot line 802 represents an effect of inlet gas temperature on the hydrogen permeation flux for case 2 (base), plot line 804 represents an effect of inlet gas temperature on the hydrogen permeation flux for case 7, and plot line 806 represents an effect of inlet gas temperature on the hydrogen permeation flux for case 8.

FIG. 8B shows a plot 810 representing an effect of inlet gas temperature on the distributions of hydrogen partial pressure on both sides of the membrane, according to certain embodiments. In plot 810, plot line 812 represents an effect of inlet gas temperature on the distributions of hydrogen partial pressure (P′_{H2}, case 2), plot line 814 represents an effect of inlet gas temperature on the distributions of hydrogen partial pressure (P′_{H2}, case 7), plot line 816 represents an effect of inlet gas temperature on the distributions of hydrogen partial pressure (P′_{H2}, case 8), plot line 818 represents an effect of inlet gas temperature on the distributions of hydrogen partial pressure (P″_{H2}, case 2), plot line 820 represents an effect of inlet gas temperature on the distributions of hydrogen partial pressure (P″_{H2}, case 7), and plot line 822 represents an effect of inlet gas temperature on the distributions of hydrogen partial pressure

(P″_{H2}, case 8).

Since no reforming reactions are activated, the main impact of the inlet gas temperature is on the membrane temperature and the hydrogen permeation rate. Equation (2) for hydrogen permeation clearly indicates that increasing the membrane surface temperature would directly enhance the hydrogen permeation flux. When the inlet gas temperature was raised from 800 K (base case, i.e., case 2) to 900 K, a higher hydrogen permeation flux was observed, as depicted in FIG. 8A and FIG. 8B. However, raising the temperature from 800 to 900 K did not result in significant changes in hydrogen partial pressure (hydrogen concentration) near the production outlet. This can be attributed to the high selectivity of the Pd—Ag membrane 118 to hydrogen, causing all available hydrogen near the Pd—Ag membrane 118 to permeate, making further temperature increases above 800-900 K insignificant for changes in outlet hydrogen concentration. On the other hand, reducing the temperature to 700 K led to a significant reduction in hydrogen concentration at the production outlet. The values of hydrogen mole fraction at the permeate outlet were 0.313, 0.340, and 0.259 at inlet gas temperatures of 800, 900, and 700 K, respectively.

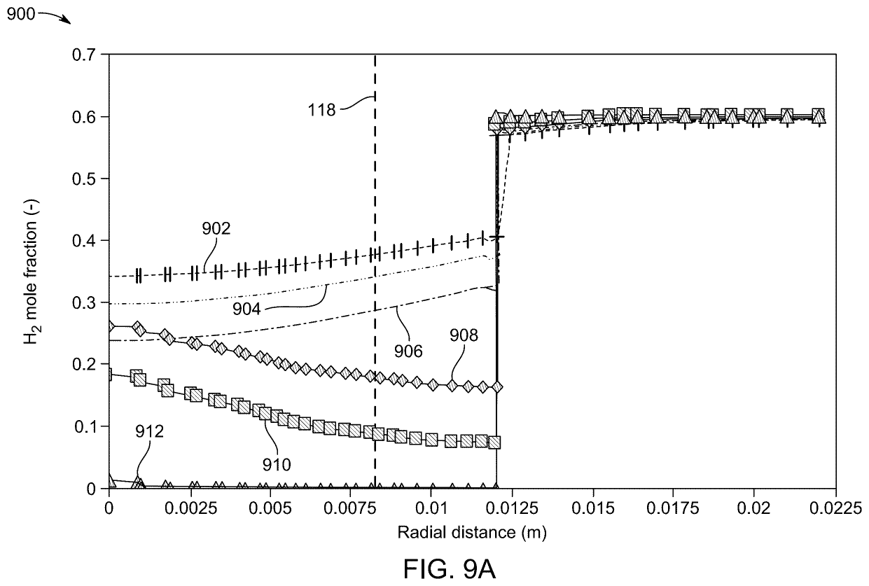

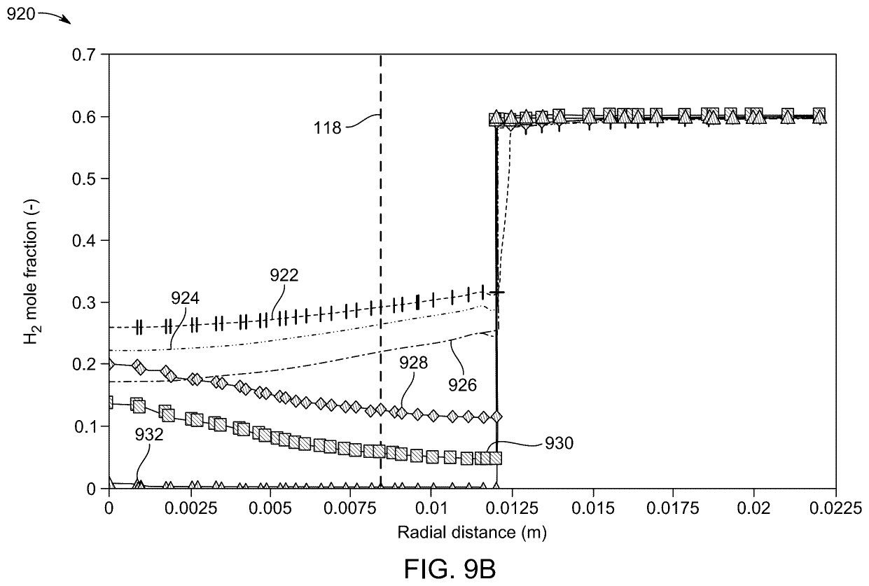

FIG. 9A shows a plot 900 representing an effect of inlet gas temperature of 900 K (case 7) on radial distributions of hydrogen mole fraction at different axial locations on an axial plane inclined by 45° (X-Y) and crossing the centerline of the Pd—Ag membrane 118, according to certain embodiments. In plot 900, plot line 902 represents an effect of inlet gas temperature of 900 K on radial distributions of hydrogen mole fraction at an axial location of Z=0.0 m, plot line 904 represents an effect of inlet gas temperature of 900 K on radial distributions of hydrogen mole fraction at an axial location of Z=0.1 m, plot line 906 represents an effect of inlet gas temperature of 900 K on radial distributions of hydrogen mole fraction at an axial location of Z×0.2 m, plot line 908 represents an effect of inlet gas temperature of 900 K on radial distributions of hydrogen mole fraction at an axial location of Z=0.3 m, plot line 910 represents an effect of inlet gas temperature of 900 K on radial distributions of hydrogen mole fraction at an axial location of Z=0.4m, and plot line 912 represents an effect of inlet gas temperature of 900 K on radial distributions of hydrogen mole fraction at an axial location of Z=0.5 m.

FIG. 9B shows a plot 920 representing an effect of inlet gas temperature of 700 K (case 8) on radial distributions of hydrogen mole fraction at different axial locations on an axial plane inclined by 45° (X-Y) and crossing the centerline of the Pd—Ag membrane 118, according to certain embodiments. In plot 920, plot line 922 represents an effect of inlet gas temperature of 700 K on radial distributions of hydrogen mole fraction at an axial location of Z=0.0 m, plot line 924 represents an effect of inlet gas temperature of 700 K on radial distributions of hydrogen mole fraction at an axial location of Z=0.1 m, plot line 926 represents an effect of inlet gas temperature of 700 K on radial distributions of hydrogen mole fraction at an axial location of Z=0.2 m, plot line 928 represents an effect of inlet gas temperature of 700 K on radial distributions of hydrogen mole fraction at an axial location of Z=0.3 m, plot line 930 represents an effect of inlet gas temperature of 700 K on radial distributions of hydrogen mole fraction at an axial location of Z=0.4 m, and plot line 932 represents an effect of inlet gas temperature of 700 K on radial distributions of hydrogen mole fraction at an axial location of Z=0.5 m.

In examples, raising the temperature improve the diffusivity of hydrogen in the feed side and widen the zone affected by hydrogen permeation. However, the porous media considered in the feed side reduces such effect of diffusivity and limits remixing of feed gases due to the presence of solid porous barriers. This results in almost identical limited affected zone by hydrogen permeation in the feed side beside the membrane surface. For all inlet gas temperatures, the sudden drop in hydrogen mole fraction takes place in the feed side at the same radial position of 0.0120 m. So, the flow of hydrogen for permeation was not able to penetrate deeper with pressure and temperature increase indicating that the pitch between membrane tubes should be reduced.

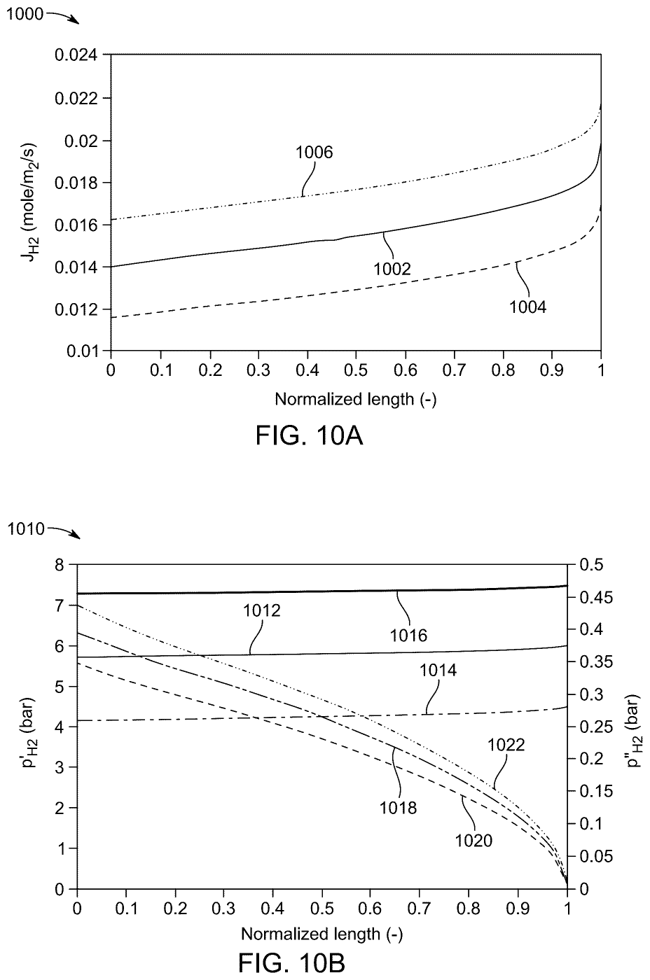

FIG. 10A shows a plot 1000 representing an effect of feed gas concentrations on the axial distributions of the hydrogen permeation flux on both sides of the membrane 118, according to certain embodiments. In plot 1000, plot line 1002 represents an effect of feed gas concentrations on the hydrogen permeation flux for case 2 (base), plot line 1004 represents an effect of feed gas concentrations on the hydrogen permeation flux for case 5, and plot line 1006 represents an effect of feed gas concentrations on the hydrogen permeation flux for case 6.

FIG. 10B shows a plot 1010 representing an effect of feed gas concentrations on the axial distributions of the hydrogen partial pressure on both sides of the membrane 118, according to certain embodiments. In plot 1010, plot line 1012 represents an effect of feed gas concentrations on the hydrogen partial pressure (P′_{H2}, case 2), plot line 1014 represents an effect of feed gas concentrations on the hydrogen partial pressure (P′_{H2}, case 5), plot line 1016 represents an effect of feed gas concentrations on the hydrogen partial pressure (P′_{H2}, case 6), plot line 1018 represents an effect of feed gas concentrations on the hydrogen partial pressure (P″_{H2}, case 2), plot line 1020 represents an effect of feed gas concentrations on the hydrogen partial pressure (P″_{H2}, case 5), and plot line 1022 represents an effect of feed gas concentrations on the hydrogen partial pressure (P″_{H2}, case 6).

As depicted in FIG. 10A and FIG. 10B, comparisons are made against the base case (case 2), which has feed gas mixture concentrations of 5% CH₄, 15% CO₂, 20% H₂O, and 60% H₂. Two other feed gas mixture concentrations were considered. Case 5 simulates conditions with weaker reforming reactions, resulting in 10% CH₄, 20% CO₂, 25% H₂O, and 45% H₂, while case 6 mimics a case of complete fuel reforming with zero concentrations of CH₄ and H₂O, and 25% CO₂ and 75% H₂. It was observed that the case with reduced feed hydrogen concentration of 45% (case 5) resulted in a lower hydrogen permeation flux compared to the base case at the same flow rate, as depicted in shown in FIG. 10A. This reduction can be attributed to the decreased hydrogen partial pressure on the feed side. Conversely, the case assuming complete fuel reforming with a hydrogen concentration of 75% (case 6) showed a higher hydrogen permeation flux due to the increased hydrogen partial pressure, as depicted in FIG. 10B.

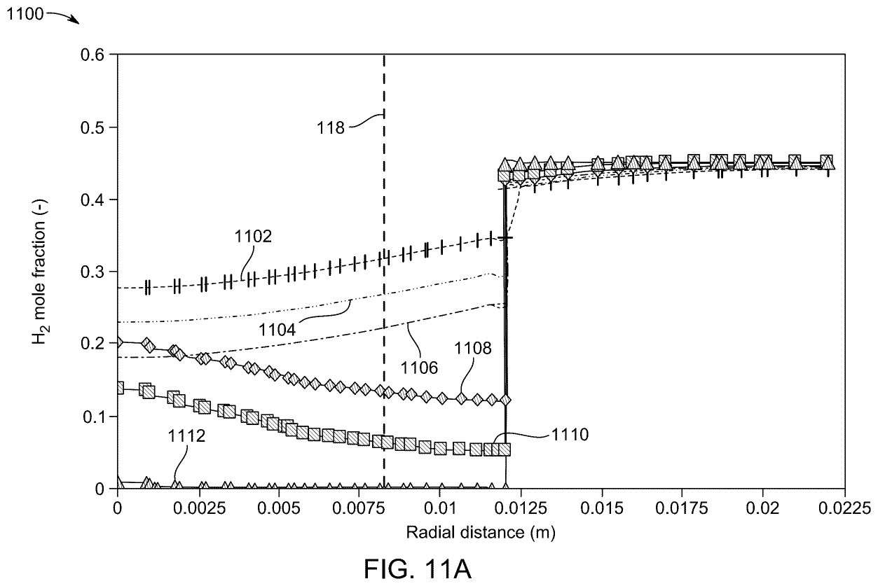

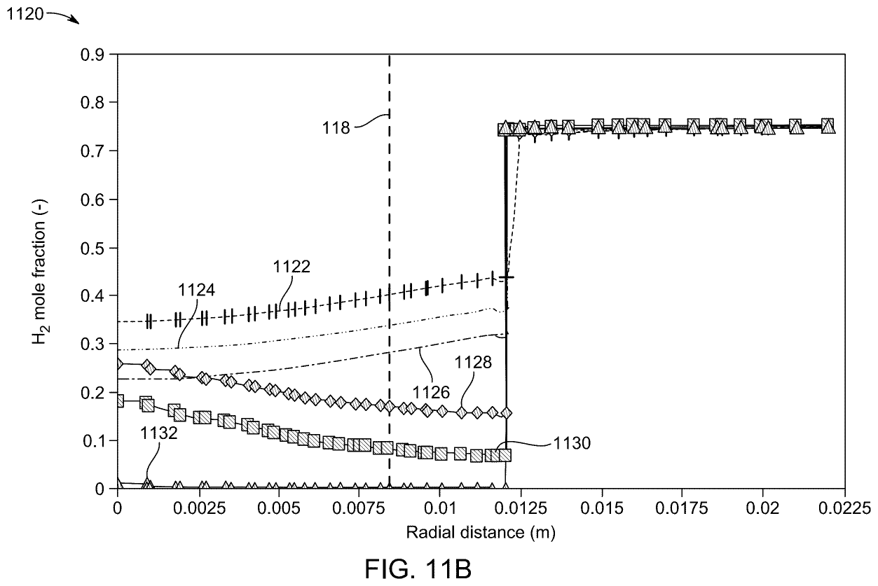

FIG. 11A shows a plot 1100 representing an effect of feed gas concentrations (case 5) on radial distributions of hydrogen mole fraction at different axial locations on an axial plane inclined by 45° (X-Y) and crossing the centerline of the Pd—Ag membrane 118, according to certain embodiments. In plot 1100, plot line 1102 represents an effect of feed gas concentrations on radial distributions of hydrogen mole fraction at an axial location of Z=0.0 m, plot line 1104 represents an effect of feed gas concentrations on radial distributions of hydrogen mole fraction at an axial location of Z=0.1 m, plot line 1106 represents an effect of feed gas concentrations on radial distributions of hydrogen mole fraction at an axial location of Z=0.2 m, plot line 1108 represents an effect of feed gas concentrations on radial distributions of hydrogen mole fraction at an axial location of Z=0.3 m, plot line 1110 represents an effect of feed gas concentrations on radial distributions of hydrogen mole fraction at an axial location of Z=0.4 m, and plot line 1112 represents an effect of feed gas concentrations on radial distributions of hydrogen mole fraction at an axial location of Z=0.5 m.

FIG. 11B shows a plot 1120 representing an effect of feed gas concentrations (case 6) on radial distributions of hydrogen mole fraction at different axial locations on an axial plane inclined by 45° (X-Y) and crossing the centerline of the Pd—Ag membrane 118, according to certain embodiments. In plot 1120, plot line 1122 represents an effect of feed gas concentrations on radial distributions of hydrogen mole fraction at an axial location of Z=0.0 m, plot line 1124 represents an effect of feed gas concentrations on radial distributions of hydrogen mole fraction at an axial location of Z=0.1 m, plot line 1126 represents an effect of feed gas concentrations on radial distributions of hydrogen mole fraction at an axial location of Z=0.2 m, plot line 1128 represents an effect of feed gas concentrations on radial distributions of hydrogen mole fraction at an axial location of Z=0.3 m, plot line 1130 represents an effect of feed gas concentrations on radial distributions of hydrogen mole fraction at an axial location of Z=0.4 m, and plot line 1132 represents an effect of feed gas concentrations on radial distributions of hydrogen mole fraction at an axial location of Z=0.5 m.

As depicted in FIG. 11A and FIG. 11B, increasing the feed hydrogen concentration resulted in higher mole fractions of hydrogen on the permeate side and lower hydrogen mole fraction on the feed side, attributable to the increased hydrogen permeation. However, this improvement in feed hydrogen concentration did not lead to better gas remixing/diffusivity, and no deeper penetrations of hydrogen flow for permeation were achieved on the feed side. Notably, the hydrogen mole fraction sharply dropped at a radial distance of 0.0120 m, regardless of the feed hydrogen concentration. This result indicates that the pitch between membrane tubes should be reduced to spread the effect of hydrogen permeation over the entire feed side domain.

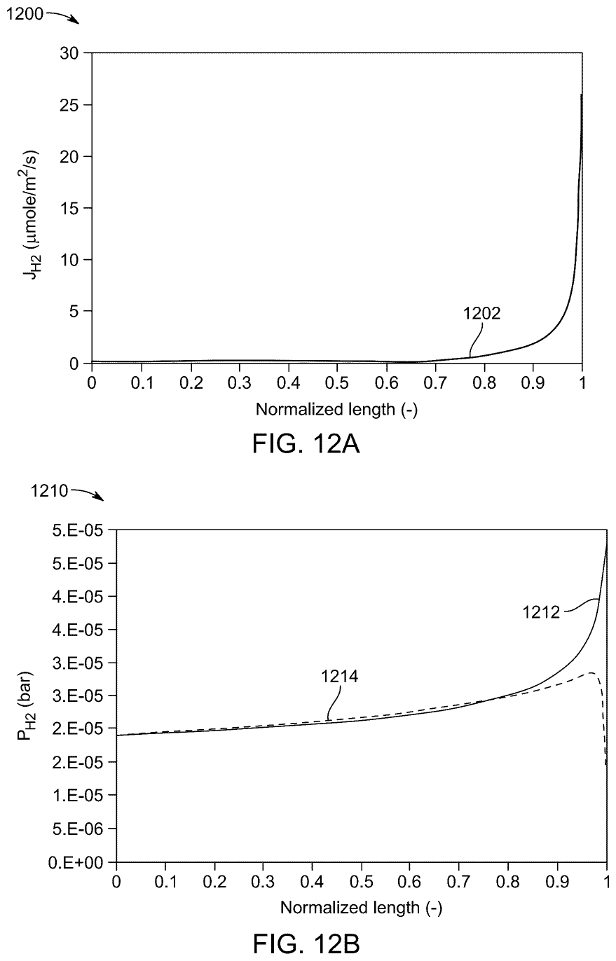

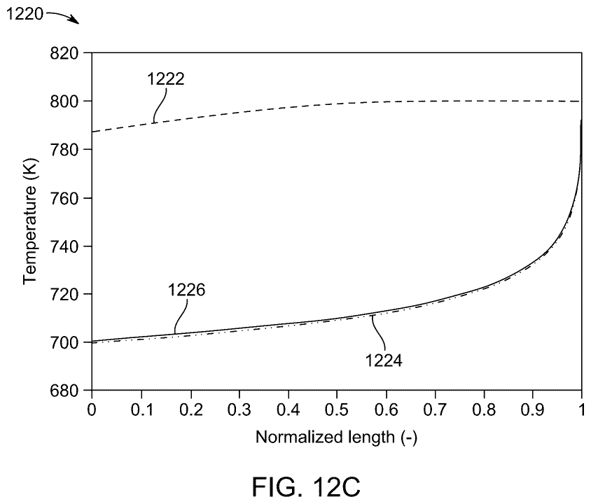

Based on the study, reducing the shell volume allows the effect of hydrogen separation to spread through the whole domain, enabling full separation of hydrogen from the reforming process in the feed side. FIG. 12A shows a plot 1200 representing axial distributions of hydrogen permeation flux, according to certain embodiments. In FIG. 12A, plot line 1202 represents an axial distribution of the hydrogen permeation flux. FIG. 12B shows a plot 1210 representing hydrogen partial pressure on both sides of the membrane 118, according to certain embodiments. In FIG. 12B, plot line 1212 represents hydrogen partial pressure of P′_{H2} and plot line 1214 represents hydrogen partial pressure of P″_{H2}. FIG. 12C shows a plot 1220 representing temperature within the MR system 100 under combined reforming and hydrogen separation conditions, according to certain embodiments. In FIG. 12C, plot line 1222 represents temperature of the sweep side of the MR system 100, plot line 1224 represents temperature of the Pd—Ag membrane 118, and plot line 1226 represents temperature of the feed side of the MR system 100.

FIG. 12A and FIG. 12B depict the reduction in hydrogen permeation flux when activating the reforming reactions in the shell side compared to cases where hydrogen is supplied in the shell side without considering reforming (FIG. 3). The hydrogen flux permeation process occurs only near the inlet of the MR system 100, approximately a quarter of the length of the MR system 100, due to the reduction in partial pressure difference across the Pd—Ag membrane 118, as depicted in FIG. 12A and FIG. 12B. The endothermic nature of the reforming reactions leads to a significant temperature reduction in the shell side of the MR system 100, slowing down hydrogen production in the feed side and subsequently reducing the hydrogen permeation flux. Moreover, the lower surface temperature of the Pd—Ag membrane 118 results in less activation of the membrane material for hydrogen separation, leading to a reduced permeation flux. This indicates that the MR system 100 requires continuous heat supply throughout the length of the MR system 100 to sustain the reforming reactions for hydrogen production.

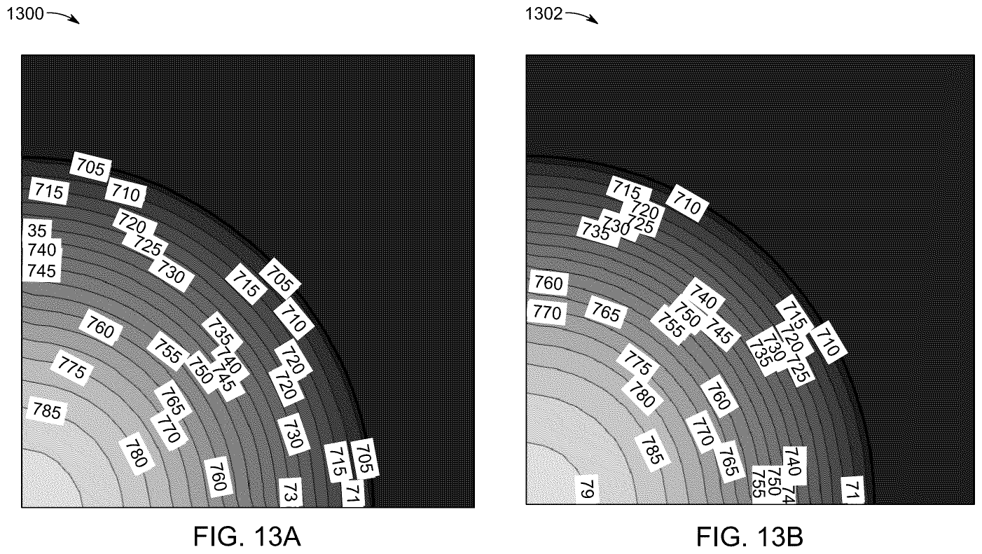

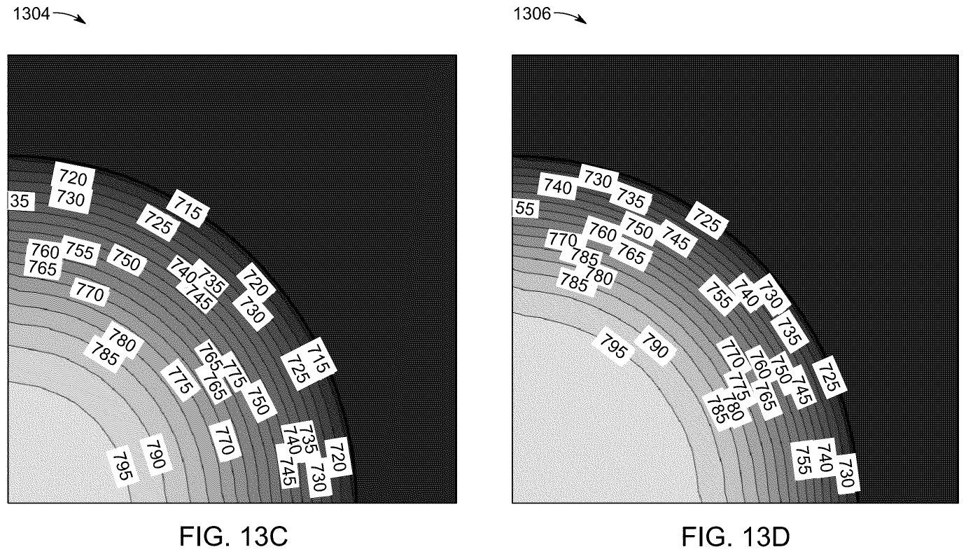

FIG. 13A shows a plot 1300 representing contours of temperature (K) on X-Y planes at different axial locations within the MR system 100 under combined reforming and hydrogen separation conditions such as Z=0.1 m, according to certain embodiments.

FIG. 13B shows a plot 1302 representing contours of temperature (K) on X-Y planes at different axial locations within the MR system 100 under combined reforming and hydrogen separation conditions such as Z=0.2 m, according to certain embodiments.

FIG. 13C shows a plot 1304 representing contours of temperature (K) on X-Y planes at different axial locations within the MR system 100 under combined reforming and hydrogen separation conditions such as Z=0.3 m, according to certain embodiments.

FIG. 13D shows a plot 1306 representing contours of temperature (K) on X-Y planes at different axial locations within the MR system 100 under combined reforming and hydrogen separation conditions such as Z=0.4 m, according to certain embodiments.

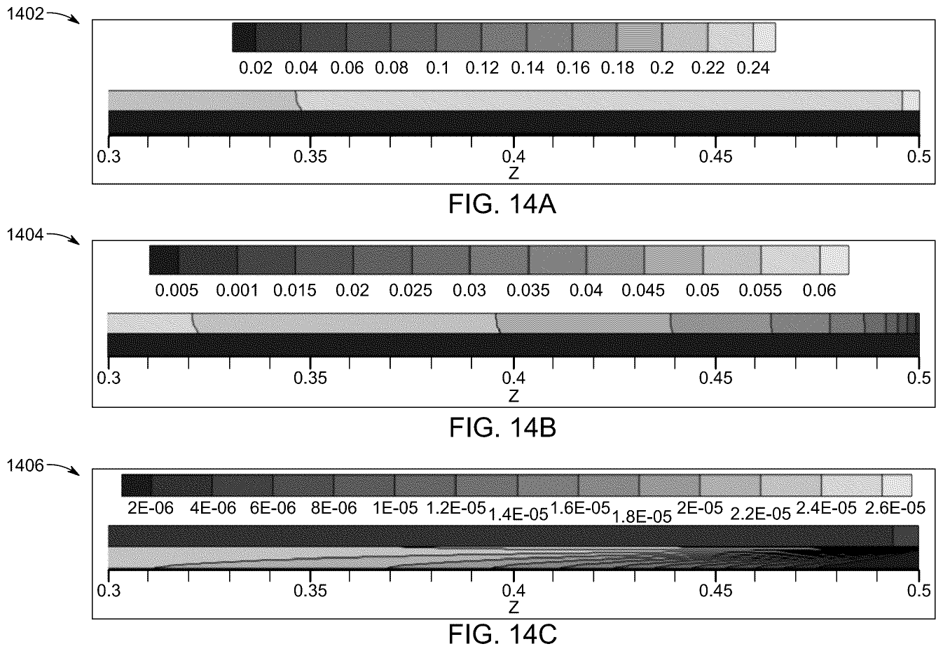

As can be seen, near the inlet of the MR system 100, at Z=0.4 m, the temperature is high, close to the inlet gas temperature of 800 K. Proceeding downstream towards the outlet of the MR system 100, as the Z value is reduced towards the exit of the MR system 100, the temperature significantly decreases due to the reforming reactions, reducing the hydrogen production rate on the shell side of the MR system 100. Additionally, the membrane surface temperature sharply drops down to about 700 K, which reduces the membrane's ability for hydrogen separation. The axial development of mole fraction distributions of CH₄, CO, and H₂ due to the processes of SMR and hydrogen separation is presented in FIG. 14A, FIG. 14B, and FIG. 14C, considering the axial distance from the inlet of the MR system 100 at Z=0.5 m to the axial location at Z=0.3 m. FIG. 14A shows a contour plot 1402 showing the axial distributions of species mole fractions on axial plane of 45° (X-Y) crossing the center of the membrane tube under combined reforming and hydrogen separation conditions for CH₄, according to certain embodiments. FIG. 14B shows a contour plot 1404 showing the axial distributions of species mole fractions on axial plane of 45° (X-Y) crossing the center of the membrane tube under combined reforming and hydrogen separation conditions for CO, according to certain embodiments. FIG. 14C shows a contour plot 1404 showing the axial distributions of species mole fractions on axial plane of 45° (X-Y) crossing the center of the membrane tube under combined reforming and hydrogen separation conditions for H₂, according to certain embodiments.

The concentrations of CH₄ reduce axially and simultaneously increase for CO, as depicted in FIG. 14A, FIG. 14B, and FIG. 14C, due to the reforming reactions that convert CH₄ to CO first, and then to CO₂ as the final product. Hydrogen is also produced in the feed side due to the reforming process and is transferred to the shell side through permeation across the Pd—Ag membrane 118. The first portion of the Pd—Ag membrane 118 near the inlet of the MR system 100, from Z=0.5 m to Z=0.47 m, does not result in any hydrogen permeation. This can be attributed to the residence time required for the reforming reactions to first produce hydrogen in the shell side before it can be permeated across the Pd—Ag membrane 118. Therefore, the shell side near the inlet of the MR system 100 is extended by 0.15 m in order to account for such a delay in reforming reactions.

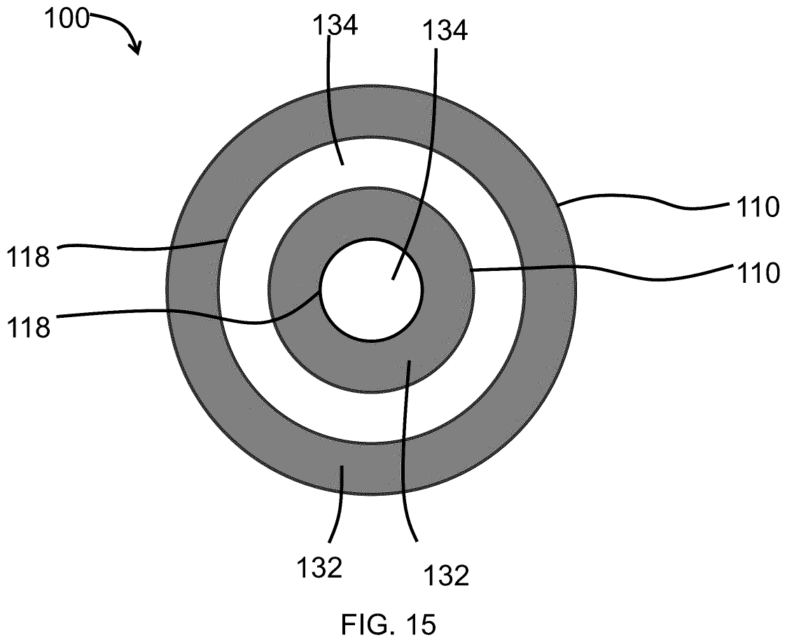

FIG. 15 shows a cross-sectional view of the MR system, according to certain embodiments. Herein, the MR system 100 include a plurality of (e.g. two) shells each being porous and including the SMR catalyst 110 and a plurality of (e.g. two) tubes each including the Pd—Ag membrane 118. The plurality of shells and the plurality of tubes are arranged concentrically and alternately. Such a configuration can achieve an area ratio of almost 1:1, preferably 0.6-0.9, preferably 0.7-0.8, preferably about 0.75, when each SMR catalyst 110 and a respective Pd—Ag membrane 118 are placed in proximity or at a predetermined distance. As a result, the SMR catalyst 110 and the Pd—Ag membrane 118 can be effectively arranged to improve the ratio of H₂ conversion on the SMR catalyst 110 to H₂ flux across the Pd—Ag membrane 118. This alternating design can also save space.

According to aspects of the present disclosure, the co-current flow configuration results in better development of hydrogen mole fractions with higher hydrogen permeation flux compared to the counter-current flow configuration. Further, hydrogen permeation is limited to a small zone near the membrane surface in the feed side while feed pressure, inlet gas temperature, and feed hydrogen concentration have little or no effect on widening the small zone, which necessitates the reduction of the shell side volume by reducing the pitch distance between membrane tubes to below 22 mm. Also, it can be observed that increasing feed pressure, inlet gas temperature, and feed hydrogen concentration results in higher hydrogen permeation flux with little or no influence on gas remixing or diffusion in the feed shell side. Hydrogen permeation rate significantly reduces under SMR conditions compared to the separation-only cases due to the higher shell side volume and quenching of the endothermic reforming reactions after short distance from the reactor inlet due to reduction in temperature.

In one embodiment, the MR system 100 includes a plurality of tubes 114 arranged in a square pattern. Neighboring tubes have a spacing of less than 22 mm. An empty volume of an enclosed space defined by the casing 136 represents space not occupied by any of the plurality of tubes 114 in the enclosed space is less than 15 vol %, preferably less than 10 vol %, preferably 5-8 vol % of a total volume of the enclosed space.

Numerous modifications and variations of the present disclosure are possible in light of the above teachings. It is therefore to be understood that within the scope of the appended claims, the invention may be practiced otherwise than as specifically described herein.

1. A membrane reactor (MR) system, comprising:
an enclosure comprising a shell, a front cap and a back cap, wherein the shell is porous and comprises a steam-methane reforming (SMR) catalyst;
a feed inlet connected to the enclosure and configured to receive a feed gas comprising CH₄ and H₂O;
at least one tube disposed inside the enclosure and having a sidewall defining a feed side and a sweep side, the feed side fluidly connected to the feed inlet to receive the feed gas that is configured to produce H₂ catalyzed by the SMR catalyst of the shell, wherein the sidewall comprises a palladium silver (Pd—Ag) membrane configured to selectively permeate the H₂ from the feed side to the sweep side;
a sweep inlet connected to the sweep side and configured to receive a sweep gas to carry and transport the H₂;
a production outlet connected to the at least one tube and configured to discharge the sweep gas and the H₂; and
a retentate outlet connected to the enclosure and configured to discharge the feed gas.

2. The MR system of claim 1, wherein the enclosure comprises a casing surrounding the shell.

3. The MR system of claim 1, wherein the SMR catalyst comprises a nickel aluminum oxide alloy including 20-40 wt. % of nickel based on a total weight of the nickel aluminum oxide alloy.

4. The MR system of claim 3, wherein the nickel aluminum oxide alloy has a bed porosity of 0.3-0.5.

5. The MR system of claim 4, wherein the nickel aluminum oxide alloy has an average particle diameter of 2.5-4.5 mm and a catalyst density of 2000-2700 kg/m³.

6. The MR system of claim 1, wherein:
the shell is longer than the Pd—Ag membrane along a longitudinal direction of the shell, and
the feed inlet is offset from the Pd—Ag membrane along the longitudinal direction of the shell so that the feed gas is configured to produce the H₂ before contacting the Pd—Ag membrane.

7. The MR system of claim 1, wherein:
the MR system comprises a plurality of shells each being porous and comprising the SMR catalyst and a plurality of tubes each comprising the Pd—Ag membrane, and
the plurality of shells and the plurality of tubes are arranged concentrically and alternately.

8. The MR system of claim 7, wherein the plurality of shells includes an outmost shell and an innermost shell, between which each tube is positioned between two neighboring shells and has a respective sweep side and two respective feed sides.

9. The MR system of claim 1, wherein the shell is spaced apart from the tube with no SMR catalyst in between.

10. The MR system of claim 1, wherein the sidewall of the tube comprises Inconel to support the Pd—Ag membrane.

11. The MR system of claim 1, wherein the sweep gas comprises water steam.

12. The MR system of claim 11, wherein the water steam is pre-heated to 600-900 K before received by the sweep inlet.

13. The MR system of claim 1, wherein the feed gas further comprises carbon oxide and hydrogen.

14. The MR system of claim 1, wherein the feed inlet and the sweep inlet are respectively connected to the front cap so that the feed gas and the sweep gas are configured to flow in a same direction in the shell.

15. The MR system of claim 1, wherein the feed inlet and the sweep inlet are respectively connected to the front cap and the back cap so that the feed gas and the sweep gas are configured to flow in opposite directions in the shell.

16. The MR system of claim 1, wherein the at least one tube and the shell are arranged concentrically.

17. The MR system of claim 1, wherein the enclosure is cylindrical.

18. The MR system of claim 1, wherein the MR system comprises a plurality of tubes arranged in a square pattern.

19. The MR system of claim 18, wherein each tube has a diameter of 10-20 millimeters, a thickness of 5-20 micrometers, and a length of 0.25-1.0 meters.

20. The MR system of claim 2, wherein:
the MR system comprises a plurality of tubes arranged in a square pattern,
neighboring tubes have a spacing of less than 22 mm, and
an empty volume of an enclosed space defined by the casing represents space not occupied by any of the plurality of tubes in the enclosed space is less than 10 vol % of a total volume of the enclosed space.
